(19) United States
(12) Patent Application Publication
(10) Pub. No.: US 2010/0017391 A1
(43) Pub. Date: Jan. 21, 2010

(54) POLARITY ESTIMATION SYSTEM, INFORMATION DELIVERY SYSTEM, POLARITY ESTIMATION METHOD, POLARITY ESTIMATION PROGRAM AND EVALUATION POLARITY ESTIMATIOM PROGRAM

(75) Inventors: Hironori Mizuguchi, Tokyo (JP); Dai Kusui, Tokyo (JP); Masaaki Tsuchida, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/448,010

(22) PCT Filed: Nov. 20, 2007
(86) PCT No.: PCT/JP2007/072484

§ 371 Date: Jun. 4, 2009

(30) Foreign Application Priority Data
Dec. 18, 2006 (JP) 2006-340307

(51) Int. Cl. G06F 7/10; G06F 17/30

(52) U.S. Cl. 707/5; 707/E17.014

(57) ABSTRACT

An evaluation polarity of reputation information with an unknown evaluation polarity is estimated by utilizing reputation information with a known evaluation polarity. The present polarity estimation system is a polarity estimation system for estimating an evaluation polarity indicating whether reputation information is positive or negative, and includes a reputation information storage part that precedently stores reputation information with a known evaluation polarity; and a polarity estimating means for estimating an evaluation polarity of reputation information with an unknown evaluation polarity on the basis of the reputation information with the known evaluation polarity precedently stored in the reputation information storage part.

This application is the National Phase of PCT/JP2007/072484, filed Nov. 20, 2007, which claims priority to Japanese Application No. 2006-340307, filed Dec. 18, 2006, the disclosures of which are incorporated by reference in their entirety.

### FIELD OF THE INVENTION

The present invention relates to a polarity estimation system, a polarity estimation method, a polarity estimation program and an evaluation polarity estimation program employed for estimating an evaluation polarity indicating whether reputation information is positive or negative, and more particularly, it relates to a polarity estimation system, a polarity estimation method, a polarity estimation program and an evaluation polarity estimation program employed for estimating an evaluation polarity of reputation information with an unknown evaluation polarity by using reputation information with a known evaluation polarity. Furthermore, the present invention relates to an information delivery system for delivering reputation information.

### BACKGROUND

In the case where given information can be classified into one of some two concepts, it is sometimes desired to perform polarity estimation for estimating which of the two concepts the information falls under. For example, there is a conventional reputation information extraction system used for extracting reputation information of a subject by inputting a natural language text. In this case, it is sometimes desired to estimate an evaluation polarity indicating whether the extracted reputation information is positive or negative.

At this point, a subject is something to be evaluated, and is, for example, the name of a product such as “personal computer X” or the name of a service such as “service Y”. Reputation information is information including an expression with a content evaluating a subject, and is, for example, information including an expression corresponding to an evaluative content such as “good”, “bad” or “large”. Herein, an expression with a content evaluating a subject (such as “good” or “bad”) is designated as an evaluative expression.

Also, reputation information may include an attribute expression corresponding to the attribute of a subject. An attribute expression is a word corresponding to a feature of a subject, and when the subject is, for example, a personal computer (hereinafter sometimes referred to simply as a PC), the attribute expression is a word such as a “screen” or a “weight”.

Furthermore, attribute expressions may be hierarchically linked. For example, the reputation information extraction system extracts, from an input sentence (a natural language text), “a PC X has a screen with a good size.”, reputation information of [a subject of “PC X”, an attribute expression of “screen”, an attribute expression of “size” and an evaluative expression of “good”].

The aforementioned case is merely an example, and when a natural language text with regard to an obvious subject, such as a text on BBS, is input, the natural language text may not clearly include a subject or the reputation information may not include a subject. When an attribute expression is omitted in a natural language text, the reputation information may not include the attribute expression. In other words, reputation information may be a three-element set of a subject, an attribute expression and an evaluative expression, or a two-element set of an attribute expression and an evaluative expression or a two-element set of a subject and an evaluative expression.

A reputation information extraction system is a system into which a natural language text is input for extracting reputation information from the input natural language text.

On the other hand, an evaluation polarity is information indicating whether or not reputation information is positive or negative. For example, the reputation information of [a subject of “PC X”, an attribute expression of “screen”, an attribute expression of “size” and an evaluative expression of “good”] includes a positive expression (that is, the expression “good” in this case), and hence, its evaluation polarity is positive. Hereinafter, an evaluation polarity is sometimes referred to simply as a polarity.

An evaluation polarity estimation system is a system into which reputation information is input for estimating an evaluation polarity of the input reputation information.

An example of the evaluation polarity estimation system is one in which every evaluative expression and a corresponding evaluation polarity are registered in a dictionary beforehand and an evaluation polarity of reputation information is estimated by using the dictionary (see, for example, Patent Document 1). The evaluation polarity estimation system disclosed in Patent Document 1 includes an evaluative expression attribute storage part, a negative expression storage part and an evaluative expression attribute classifying means. The evaluative expression attribute storage part stores beforehand sets each of an evaluative expression and information indicating whether the evaluative expression is positive or negative. The negative expression storage part stores negative expressions such as “do not” and “did not”. The evaluative expression attribute classifying means classifies reputation information into positive one or negative one.

The evaluative expression attribute classifying means receives, as inputs, a natural language text and position information corresponding to the appearance position of an evaluative expression. Then, the evaluative expression attribute classifying means classifies the reputation information into positive one or negative one on the basis of a set of the evaluation polarity of the evaluative expression and a negative expression appearing around the evaluative expression by referring to the evaluative expression attribute storage part.

Moreover, evaluative expressions frequently appear continuously in a text, and a positive evaluative expression tends to follow or be followed by a positive evaluative expression and a negative evaluative expression tends to follow or be followed by a negative evaluative expression. A system having a structure for determining an evaluation polarity of reputation information on the hypothesis of such tendency is, for example, disclosed in Patent Document 2.

An evaluation polarity estimation system disclosed in Patent Document 2 includes a registered expression storage part, an expression extraction part and a polarity determination part. The registered expression storage part stores beforehand sets each of an evaluative expression and information indicating whether the evaluative expression is positive or negative. The expression extraction part extracts a noun phrase or a verb phrase from a natural language text. The polarity determination part determines, by referring to the registered expression storage part, that a verb phrase appearing together with an evaluative expression has the same evaluation polarity as the evaluative expression. In the evaluation polarity estimation system disclosed in Patent Document 2, when an evaluation polarity of a verb phrase not registered beforehand in the registered expression storage part is beyond a threshold value, the verb phrase is estimated to have the evaluation polarity.

Patent Document 1: Japanese Laid-Open Patent Publication No. 2002-92004 (p. 9 and FIG. 9)

Patent Document 2: Japanese Laid-Open Patent Publication No. 2006-146567 (pp. 9-10 and FIG. 3)

In the evaluation polarity estimation system disclosed in Patent Document 1, the polarity of reputation information is determined in estimation of the evaluation polarity merely on the basis of an evaluative expression. Therefore, there arises a first problem in the evaluation polarity estimation system of Patent Document 1 that evaluation properties of all evaluative expressions should be registered beforehand.

There still arises another problem in the evaluation polarity estimation system of Patent Document 1 that it is sometimes difficult to determine an evaluation polarity merely on the basis of an evaluative expression. For example, evaluative expressions of “like” and “splendid” can be determined as positive evaluative expressions and evaluative expressions of “hate” and “awkward” can be determined as negative evaluative expressions in general. An evaluative expression of “large”, however, cannot be determined unconditionally as a positive expression or a negative expression. Specifically, with respect to reputation information of [a subject of “PC”, an attribute expression of “screen” and an evaluative expression of “large”], “large” is positive reputation information, but with respect to reputation information of [a subject of “PC”, an attribute expression of “noise” and an evaluative expression of “large”], “large” is negative reputation information. Accordingly, an evaluation polarity cannot be sometimes determined merely on the basis of an evaluative expression.

Furthermore, in the evaluation polarity estimation system disclosed in Patent Document 2, a polarity cannot be determined unless two or more evaluative expressions are present in the same clause or phrase as an evaluative expression. Therefore, there arises a second problem that evaluation polarities can be obtained with respect to merely limited reputation information by using the evaluation polarity estimation system of Patent Document 2.

### SUMMARY OF INVENTION

An exemplary object of the invention is providing a polarity estimation system, an information delivery system, a polarity estimation method, a polarity estimation program and an evaluation polarity estimation program in which an evaluation polarity of reputation information can be determined without registering evaluative polarity of all evaluative expressions beforehand.

The first polarity estimation system in accordance with an exemplary aspect of the invention is a polarity estimation system for estimating an evaluation polarity indicating whether reputation information is positive or negative, including an evaluative expression storage part that stores an evaluative expression corresponding to an expression of evaluation of a subject and an evaluative expression polarity indicating whether the evaluative expression includes a positive expression or a negative expression correspondingly to each other; a reputation information storage part that stores reputation information and an evaluation polarity of the reputation information correspondingly to each other; and a polarity estimating means that estimates an evaluation polarity of reputation information with an unknown evaluation polarity on the basis of the evaluative expression and the evaluative expression polarity stored in the evaluative expression storage part and estimates the evaluation polarity of the reputation information with the unknown evaluation polarity on the basis of the reputation information and the evaluation polarity stored in the reputation information storage part, and the reputation information storage part stores, correspondingly to the reputation information, acquirement time information indicating time when the reputation information was acquired, the polarity estimating means includes a weighting means that performs prescribed weighting processing on the evaluation polarity corresponding to the reputation information stored in the reputation information storage part on the basis of the acquirement time information stored in the reputation information storage part, and the weighting means estimates the evaluation polarity of the reputation information with the unknown evaluation polarity on the basis of an evaluation polarity resulting from the weighting processing and the reputation information stored in the reputation information storage part.

The second polarity estimation system in accordance with an exemplary aspect of the invention is a polarity estimation system, in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, including an evaluative expression storage part that stores an evaluation polarity corresponding to an evaluative expression; a reputation information storage part that stores reputation information and an evaluation polarity corresponding to the reputation information; and a polarity estimating means that estimates the evaluation polarity of the input reputation information on the basis of the evaluation polarity stored in the evaluative expression storage part and the reputation information with the known evaluation polarity stored in the reputation information storage part and calculates, as the evaluation polarity, a polarity degree corresponding to a positive degree or a negative degree of the reputation information, and the polarity estimating means calculates a polarity degree corresponding to an attribute expression included in the reputation information with the known evaluation polarity, a polarity degree corresponding to a subject included in the reputation information and a polarity degree corresponding to an evaluative expression included in the reputation information, and the polarity estimating means calculates a comprehensive polarity degree obtained by comprehensively integrating a polarity degree corresponding to the attribute expression, a polarity degree corresponding to the subject and a polarity degree corresponding to the evaluative expression calculated with respect to the input reputation information on the basis of one of the calculated polarity degrees or a set of two or more of the calculated polarity degrees calculated with respect to the reputation information with the known evaluation polarity.

The third polarity estimation system in accordance with an exemplary aspect of the invention is a polarity estimation system in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, including an evaluative expression storage part that stores an evaluation polarity of an evaluative expression; a reputation information storage part that stores reputation information and an evaluation polarity of the reputation information; and a polarity estimating means that estimates the evaluation polarity of the input reputation information on the basis of the evaluation polarity stored in the evaluative expression storage part and the reputation information with the known evaluation polarity stored in the reputation information storage part, and the polarity estimating means calculates, as the evaluation polarity, a polarity degree corresponding to a positive degree or a negative degree of the reputation information.

The fourth polarity estimation system in accordance with an exemplary aspect of the invention is a polarity estimation system, employed when information to be estimated is able to be classified into one of two concepts, for estimating a polarity indicating which concept the information to be evaluated falls under, including an information storage part that precedently stores information with a known polarity; and a polarity estimating means that estimates a polarity of information with an unknown polarity on the basis of the information with the known polarity precedently stored in the information storage part.

The first information delivery system in accordance with an exemplary aspect of the invention is an information delivery system including a reputation information delivery system that delivers reputation information; and an evaluation polarity estimation system that estimates an evaluation polarity indicating whether reputation information is positive or negative, and the evaluation polarity estimation system includes an evaluative expression storage part that stores an evaluation polarity corresponding to an evaluative expression; a reputation information storage part that stores reputation information and an evaluation polarity corresponding to the reputation information; and a polarity estimating means that calculates a polarity degree corresponding to an attribute expression included in reputation information with a known evaluation polarity, a polarity degree corresponding to a subject included in the reputation information and a polarity degree corresponding to an evaluative expression included in the reputation information, calculates a comprehensive polarity degree obtained by comprehensively integrating a polarity degree corresponding to an attribute expression, a polarity degree corresponding to a subject and a polarity degree corresponding to an evaluative expression calculated with respect to input reputation information on the basis of one of the calculated polarity degrees or a set of two or more of the calculated polarity degrees calculated with respect to the reputation information with the known evaluation polarity, and calculates, as the evaluation polarity, a polarity degree corresponding to a positive degree or a negative degree of the reputation information, and the reputation information delivery system includes an information delivering means that transmits not only the reputation information but also the evaluation polarity estimated by the evaluation polarity estimation system to a user terminal through a communication network.

The first polarity estimation method in accordance with an exemplary aspect of the invention is a polarity estimation method for estimating an evaluation polarity indicating whether reputation information is positive or negative, including an evaluative expression storing step of storing an evaluative expression corresponding to an expression of evaluation of a subject and an evaluative expression polarity indicating whether the evaluative expression includes a positive expression or a negative expression correspondingly to each other; a reputation information storing step of storing reputation information and an evaluation polarity of the reputation information correspondingly to each other; and a polarity estimating step of estimating an evaluation polarity of reputation information with an unknown evaluation polarity on the basis of the evaluative expression and the evaluative expression polarity stored in the evaluative expression storing step and estimating the evaluation polarity of the reputation information with the unknown evaluation polarity on the basis of the reputation information and the evaluation polarity stored in the reputation information storing step, and acquirement time information indicating time when the reputation information was acquired is stored correspondingly to the reputation information in the reputation information storing step, prescribed weighting processing is performed on the evaluation polarity corresponding to the stored reputation information on the basis of the stored acquirement time information in the polarity estimating step, and the evaluation polarity of the reputation information with the unknown evaluation polarity is estimated in the polarity estimating step on the basis of an evaluation polarity resulting from the weighting processing and the stored reputation information.

The second polarity estimation method in accordance with an exemplary aspect of the invention is a polarity estimation method in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, including an evaluative expression storing step of storing an evaluation polarity corresponding to an evaluative expression; a reputation information storing step of storing reputation information and an evaluation polarity corresponding to the reputation information; and a polarity estimating step of estimating the evaluation polarity of the input reputation information on the basis of the evaluation polarity stored in the evaluative expression storing step and the reputation information with the known evaluation polarity stored in the reputation information storing step and calculating, as the evaluation polarity, a polarity degree corresponding to a positive degree or a negative degree of the reputation information, and a polarity degree corresponding to an attribute expression included in the reputation information with the known evaluation polarity, a polarity degree corresponding to a subject included in the reputation information and a polarity degree corresponding to an evaluative expression included in the reputation information are calculated in the polarity estimating step, and a comprehensive polarity degree is calculated in the polarity estimating step by comprehensively integrating a polarity degree corresponding to the attribute expression, a polarity degree corresponding to the subject and a polarity degree corresponding to the evaluative expression calculated with respect to the input reputation information on the basis of one of the calculated polarity degrees or a set of two or more of the calculated polarity degrees calculated with respect to the reputation information with the known evaluation polarity.

The third polarity estimation method in accordance with an exemplary aspect of the invention is a polarity estimation method in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, including an evaluative expression storing step of storing an evaluation polarity of an evaluative expression; a reputation information storing step of storing reputation information and an evaluation polarity of the reputation information; and a polarity estimating step of estimating the evaluation polarity of the input reputation information on the basis of the stored evaluation polarity and the stored reputation information with the known evaluation polarity, and a polarity degree corresponding to a positive degree or a negative degree of the reputation information is calculated as the evaluation polarity in the polarity estimating step.

The first polarity estimation program in accordance with an exemplary aspect of the invention is a polarity estimation program, used for estimating an evaluation polarity indicating whether reputation information is positive or negative, that causes a computer to execute evaluative expression storing processing for storing an evaluative expression corresponding to an expression of evaluation of a subject and an evaluative expression polarity indicating whether the evaluative expression includes a positive expression or a negative expression correspondingly to each other; reputation information storing processing for storing reputation information and an evaluation polarity of the reputation information correspondingly to each other; and polarity estimating processing for estimating an evaluation polarity of reputation information with an unknown evaluation polarity on the basis of the stored evaluative expression and evaluative expression polarity and estimating the evaluation polarity of the reputation information with the unknown evaluation polarity on the basis of the stored reputation information and evaluation polarity, and the computer is caused to execute, in the reputation information storing processing, processing for storing, correspondingly to the reputation information, acquirement time information indicating time when the reputation information was acquired, the computer is caused to execute, in the polarity estimating processing, prescribed weighting processing on the evaluation polarity corresponding to the stored reputation information on the basis of the stored acquirement time information, and the computer is caused to execute, in the polarity estimating processing, processing for estimating the evaluation polarity of the reputation information with the unknown evaluation polarity on the basis of an evaluation polarity resulting from the weighting processing and the stored reputation information

The second polarity estimation program in accordance with an exemplary aspect of the invention is a polarity estimation program, in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, that causes a computer to execute evaluative expression storing processing for storing an evaluation polarity corresponding to an evaluative expression; reputation information storing processing for storing reputation information and an evaluation polarity corresponding to the reputation information; and polarity estimating processing for estimating the evaluation polarity of the input reputation information on the basis of the evaluation polarity stored in the evaluative expression storing processing and the reputation information with the known evaluation polarity stored in the reputation information storing processing and calculating, as the evaluation polarity, a polarity degree corresponding to a positive degree or a negative degree of the reputation information, and the computer is caused to execute, in the polarity estimating processing, processing for calculating a polarity degree corresponding to an attribute expression included in the reputation information with the known evaluation polarity, a polarity degree corresponding to a subject included in the reputation information and a polarity degree corresponding to an evaluative expression included in the reputation information, and the computer is caused to execute, in the polarity estimating processing, processing for calculating a comprehensive polarity degree obtained by comprehensively integrating a polarity degree corresponding to the attribute expression, a polarity degree corresponding to the subject and a polarity degree corresponding to the evaluative expression calculated with respect to the input reputation information on the basis of one of the calculated polarity degrees or a set of two or more of the calculated polarity degrees calculated with respect to the reputation information with the known evaluation polarity.

The third polarity estimation program in accordance with an exemplary aspect of the invention is a polarity estimation program, in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, that causes a computer to execute evaluative expression storing processing for storing an evaluation polarity of an evaluative expression; reputation information storing processing for storing reputation information and an evaluation polarity of the reputation information; and polarity estimating processing for estimating the evaluation polarity of the input reputation information on the basis of the stored evaluation polarity and the stored reputation information with the known evaluation polarity, and the computer is caused to execute, in the polarity estimating processing, processing for calculating, as the evaluation polarity, a polarity degree corresponding to a positive degree or a negative degree of the reputation information.

The first evaluation polarity estimation program in accordance with an exemplary aspect of the invention is an evaluation polarity estimation program to be provided onboard in a computer, in which reputation information including a subject to be evaluated, an attribute expression corresponding to an attribute of the subject and an evaluative expression corresponding to an expression of evaluation of the subject is input for outputting an evaluation polarity indicating whether the input reputation information is positive or negative, that causes the computer to execute inputting processing for inputting reputation information; processing for calculating a polarity degree of an attribute expression included in reputation information with a known evaluation polarity; processing for calculating a polarity degree of a subject included in the reputation information with the known evaluation polarity; processing for calculating a polarity degree of an evaluative expression included in the reputation information with the known evaluation polarity; and processing for calculating the polarity of the input reputation information by calculating a comprehensive polarity degree obtained by comprehensively integrating the calculated polarity degrees of the attribute expression, the subject and the evaluative expression.

The present invention provides a polarity estimation system, an information delivery system, a polarity estimation method, a polarity estimation program and an evaluation polarity estimation program in which an evaluation polarity of reputation information can be determined without registering evaluative polarity of all evaluative expressions beforehand.

### BRIEF DESCRIPTION OF DRAWINGS

FIG. 1 is a block diagram illustrating an exemplary structure of a polarity estimation system according to an exemplary embodiment of the invention.

FIG. 2 is an explanatory diagram illustrating examples of an evaluative expression and an evaluation polarity stored in an evaluative expression storage part.

FIG. 3 is an explanatory diagram illustrating examples of reputation information and an evaluation polarity stored in a reputation information storage part.

FIG. 4 is an explanatory diagram illustrating other examples of the reputation information and the evaluation polarity stored in the reputation information storage part.

FIG. 5 is a block diagram illustrating an exemplary structure of a polarity estimating means.

FIG. 6 is a flowchart illustrating an exemplary process for estimating an evaluation polarity by the evaluation polarity estimation system.

FIG. 7 is a block diagram illustrating an exemplary structure of a polarity estimation system according to another exemplary embodiment of the invention.

FIG. 8 is an explanatory diagram illustrating examples of reputation information, an acquirement date and an evaluation polarity stored in a reputation information storage part.

FIG. 9 is a block diagram illustrating an exemplary structure of a polarity estimating means.

FIG. 10 is a flowchart illustrating an exemplary process for estimating an evaluation polarity by the evaluation polarity estimation system.

FIG. 11 is a block diagram illustrating an exemplary structure of a polarity estimation system according to another exemplary embodiment of the invention.

FIG. 12 is an explanatory diagram illustrating examples of reputation information, an evaluator ID and an evaluation polarity stored in a reputation information storage part.

FIG. 13 is an explanatory diagram illustrating examples of evaluator type information stored in an evaluator type storage part.

FIG. 14 is a block diagram illustrating an exemplary structure of a polarity estimating means.

FIG. 15 is a flowchart illustrating an exemplary process for estimating an evaluation polarity by the evaluation polarity estimation system.

FIG. 16 is a block diagram illustrating a specific exemplary architecture of an evaluation polarity estimation system.

FIG. 17 is a block diagram illustrating an exemplary structure of an information service system according to another exemplary embodiment of the invention.

FIG. 18 is a block diagram illustrating an exemplary structure of a polarity estimation system according to the exemplary embodiment of the invention.

FIG. 19 is a flowchart illustrating an exemplary process for delivering reputation information to a service user terminal.

FIG. 20 is a flowchart illustrating an exemplary process for reviewing reputation information and an evaluation polarity.

FIG. 21 is a block diagram illustrating an exemplary structure of a polarity estimation system according to another exemplary embodiment of the invention.

FIG. 22 is an explanatory diagram illustrating examples of various expressions and polarities stored in an expression storage part.

FIG. 23 is an explanatory diagram illustrating examples of a keyword set and polarities stored in an information storage part.

### DETAILED DESCRIPTION OF PREFERRED EMBODIMENTS

According to the present invention, an evaluation polarity is estimated by calculating an evaluation polarity degree by a statistical method on the basis of the following several hypotheses on reputation information. Herein, an evaluation polarity degree is a numerical value indicating whether it is positive reputation information or negative reputation information. An evaluation polarity degree is, for example, a real number ranging from 1 to −1. In this case, as an evaluation polarity degree is closer to 1, the reputation information is more positive, and as an evaluation polarity degree is closer to −1, the reputation information is more negative. Hereinafter, an evaluation polarity degree is sometimes designated simply as a polarity degree. It is noted that these numerical values are merely exemplarily mentioned, and other numerical values ranging from, for example, “100” to “0” may be used or discrete numerical values may be used instead of continuous numerical values.

Hypothesis 1) Polarities can be precedently determined with respect to some evaluative expressions, and a polarity of reputation information including such an expression tends to be the same as the polarity of the evaluative expression. As described above, when an evaluative expression is “large”, its polarity cannot be determined. There are, however, cases where the polarity can be determined merely on the basis of an evaluative expression. For example, evaluative expressions of “good” and “splendid” are obviously positive evaluative expressions, and therefore, the polarity of reputation information including such an evaluative expression can be regarded to be positive. On the other hand, evaluative expressions of “bad” and “dirty” are obviously negative evaluative expressions, and therefore, the polarity of reputation information including such an evaluative expression is similarly negative.

Hypothesis 2) There are expressions with good impression and expressions with bad impression among attribute expressions, and reputation information including an expression with good impression and one including an expression with bad impression tend to be positive and negative evaluative expressions, respectively. For example, an attribute expression of “brightness” is an expression with good impression, and an attribute expression of “noise” is an expression with bad impression. Therefore, reputation information respectively including these attribute expressions tend to be positive and negative, respectively. Examples are “a PC X has the best brightness” and “a PC Z is no good because of noise”. Accordingly, the polarity of reputation information can be determined by using an attribute expression in some cases.

On the basis of the aforementioned hypotheses 1 and 2, an evaluation polarity estimation system according to the present invention includes a reputation information storage part, an evaluative expression storage part and a polarity estimating means. The polarity estimating means receives reputation information as an input and calculates a polarity degree of reputation information with an unknown polarity by referring to polarity degrees of reputation information stored in the reputation information storage part and evaluative expressions and their polarity degrees stored in the evaluative expression storage part.

The polarity estimating means first refers to reputation information with known polarities, so as to calculate a polarity degree of an evaluative expression, a polarity degree of an attribute expression, and a polarity degree of a set of the attribute expression and the evaluative expression included in the input reputation information. Each polarity degree is calculated by using the amount of reputation information with known polarity degrees including the evaluative expression, the attribute expression or the set of the evaluative expression and the attribute expression, or by using an average value of the polarity degrees, a ratio between the amount of positive reputation information or the amount of negative reputation information, or the like. Next, these calculated polarity degrees are integrated so as to output a comprehensive polarity degree.

When the aforementioned structure is employed so as to calculate a polarity degree by the polarity estimating means in consideration whether an attribute expression is used with good impression or bad impression on the basis of reputation information with known polarities, the object of the invention can be achieved.

Hypothesis 3) When there is a sufficiently large amount of reputation information, a ratio in amount between positive reputation information and negative reputation information of every subject calculated merely on the basis of reputation information with known polarities tends to be affected by a ratio in the whole reputation information. For example, although evaluation of a specific PC is divided into two sides, a tendency that positive opinions are dominant can be grasped. Such a tendency is calculated on the basis of reputation information with known polarities. Specifically, on the assumption that reputation information with unknown polarities show the same tendency, a polarity can be estimated.

On the basis of the aforementioned hypothesis 3, an evaluation polarity estimation system according to the present invention includes a reputation information storage part, an evaluative expression storage part and a polarity estimating means, and the polarity estimating means receives reputation information as an input, and calculates a polarity degree of reputation information with an unknown polarity by referring to reputation information and their polarity degrees stored in the reputation information storage part and evaluative expressions and their polarity degrees stored in the evaluative expression storage part.

The polarity estimating means first refers to reputation information with known polarities, and calculates a polarity degree of an evaluative expression, a polarity degree of a subject and a polarity degree of a set of the subject and the evaluative expression included in the input reputation information. The polarity degree is calculated by referring to the reputation information with the known polarities and by using the amounts, the ratio or the like of positive reputation information and negative reputation information with respect to every evaluative expression, every subject and every set of an evaluative expression and a subject. Next, the evaluative expression and the subject included in the input reputation information and the calculated respective polarity degrees are compared, so as to output a polarity degree.

When the aforementioned structure is employed so as to calculate a polarity degree by the polarity estimating means on the basis of reputation information with known polarities, the object of the invention can be achieved.

Furthermore, on the basis of the aforementioned hypotheses 1, 2 and 3, an evaluation polarity estimation system according to the present invention includes a reputation information storage part, an evaluative expression storage part and a polarity estimating means, and the polarity estimating means receives reputation information as an input, and calculates a polarity degree of reputation information with an unknown polarity by referring to reputation information and their polarity degrees stored in the reputation information storage part and evaluative expressions and their polarity degrees stored in the evaluative expression storage part.

The polarity estimating means first calculates a polarity degree of every evaluative expression, a polarity degree of every attribute expression, a polarity degree of a set of an attribute expression and an evaluative expression, a polarity degree of a set of a subject and an evaluative expression, and a polarity degree of a set of a subject, an attribute expression and an evaluative expression. By referring to reputation information with known polarities, a polarity degree is calculated by using the amounts, the ratio or the like of positive reputation information and negative reputation information with respect to every evaluative expression, every attribute expression, every subject, every set of an evaluative expression and an attribute expression, every set of an evaluative expression and a subject and every set of an evaluative expression, an attribute expression and a subject. Next, an evaluative expression, an attribute expression and a subject included in the input reputation information and the respective polarities precedently calculated are compared, so as to output a polarity degree.

Hypothesis 4) Reputation information may change with time. It is regarded that reputation of a subject gradually changes with time. For example, reputation of a succor player in a given period of time changes in accordance with his contribution to goals and the outcome of a previous game. Accordingly, also in estimating a polarity of reputation information, it is necessary to consider the elapse of time by, for example, weighting a polarity of recent reputation information.

In addition to the aforementioned evaluation polarity estimation systems, on the basis of the aforementioned hypothesis 4, an evaluation polarity estimation system according to the present invention includes a reputation information storage part, an evaluative expression storage part and a polarity estimating means, and the polarity estimating means calculates a polarity degree by weighting recent reputation information stored in the reputation information storage part.

Hypothesis 5) Evaluation of reputation information may depend upon the type of an evaluator. The types of evaluators are classified in accordance with a sex, an age, an address, an occupation, an interest, a history of purchased products, and the like. For example, evaluation of a product may be changed in accordance with such types of evaluators. For example, there is a product popular among women but unpopular among men, or there is a PC popular among evaluators interested in PCs and possessing several PCs but unpopular among other evaluators. Accordingly, also in estimating a polarity of reputation information, it is necessary to consider the type of an evaluator.

In addition to the aforementioned evaluation polarity estimation systems, on the basis of the hypothesis 5, an evaluation polarity estimation system according to the present invention includes a reputation information storage part, an evaluative expression storage part, an evaluator type storage part and a polarity estimating means, and the polarity estimating means further calculates a polarity degree with respect to every type of evaluators by referring to the evaluator type storage part.

According to the present invention, an evaluation polarity of reputation information with an unknown evaluation polarity is estimated on the basis of precedently stored reputation information with known polarities. Accordingly, an evaluation polarity of reputation information with an unknown evaluation polarity can be estimated by using reputation information with known evaluation polarities. Therefore, an evaluation polarity of reputation information can be determined without precedently registering evaluative polarity of all evaluative expressions.

Furthermore, when the present invention employs a structure in which prescribed weighting processing is executed on an evaluation property of stored reputation information on the basis of acquirement time information corresponding to time when the reputation information was acquired and an evaluation polarity of reputation information with an unknown evaluation polarity is estimated on the basis of an evaluation polarity resulting from the weighting processing, a polarity of reputation information can be estimated in consideration of change with time of the reputation information.

Moreover, when the present invention employs a structure in which an evaluation polarity of reputation information with an unknown evaluation polarity is estimated on the basis of evaluator information corresponding to an evaluator having evaluated the reputation information, a polarity of reputation information can be estimated in consideration of a bias derived from the type of an evaluator for the reputation information.

Now, preferred exemplary embodiments of the invention will be described in detail.

### Exemplary Embodiment 1

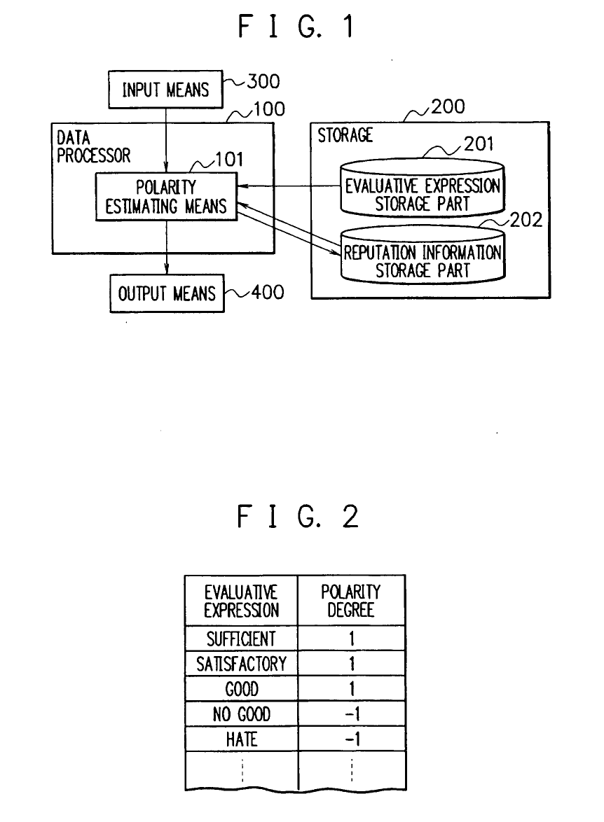

Exemplary embodiment 1 of the invention will now be described with reference to the accompanying drawings. FIG. 1 is a block diagram illustrating an exemplary structure of a polarity estimation system of this invention. In this exemplary embodiment, an exemplified case where the polarity estimation system is an evaluation polarity estimation system for estimating an evaluation polarity of reputation information will be described. In this exemplary embodiment, the evaluation polarity estimation system is applicable to, for example, an automatic survey collating system for automatically collating survey results or an information service system for delivering reputation information and evaluation polarities.

As illustrated in FIG. 1, the evaluation polarity estimation system includes a data processor 100 operated under program control; a storage 200 for storing information; an input means 300; and an output means 400. The evaluation polarity estimation system is specifically realized by an information processor operated in accordance with a program, such as a work station or a personal computer.

The input means 300 is realized specifically by an input device of the information processor, such as a keyboard or a mouse. The input means 300 is operated by, for example, a user in inputting reputation information to be evaluated. In the case where the reputation information to be evaluated is received through a communication network, the input means 300 may be realized by a network interface unit included in the information processor.

The output means 400 is realized specifically by a display device such as a display. The output means 400 has a function to output (for example, to display) an estimation result for an evaluation polarity of reputation information. In the case where an estimation result for the evaluation polarity is output through a communication network, the output means 400 may be realized by a network interface unit included in the information processor. Alternatively, the output means 400 may be a printing device such as a printer.

The data processor 100 is realized specifically by a CPU of the information processor operated in accordance with a program. The data processor 100 includes a polarity estimating means 101. The storage 200 is realized specifically by a database device such as a magnetic disk unit or an optical disk unit. The storage 200 includes an evaluative expression storage part 201 and a reputation information storage part 202. These components are operated roughly as follows:

The evaluative expression storage part 201 precedently stores evaluative expressions with known evaluation polarities. FIG. 2 is an explanatory diagram illustrating examples of evaluative expressions and their evaluation polarities stored in the evaluative expression storage part 201. As illustrated in FIG. 2, the evaluative expression storage part 201 is a database in which an evaluative expression and a polarity degree (an evaluation polarity) are stored correspondingly to each other. In this exemplary embodiment, a polarity degree is a value ranging from “1” to “−1”, and as a polarity degree is closer to “1”, the corresponding evaluative expression is more positive. On the other hand, as a polarity degree is closer to “−1”, the corresponding evaluative expression is more negative.

It is noted that the evaluation polarities listed in FIG. 2 are merely exemplarily mentioned, and a polarity degree may be represented by other numerical values, for example, ranging from “100” to “0”. Also, numerical values may be discretely used and an evaluation polarity may be represented by a symbol such as “∘” or “×”, or an evaluation polarity may be dividedly indicated in a column of a positive degree and a column of a negative degree.

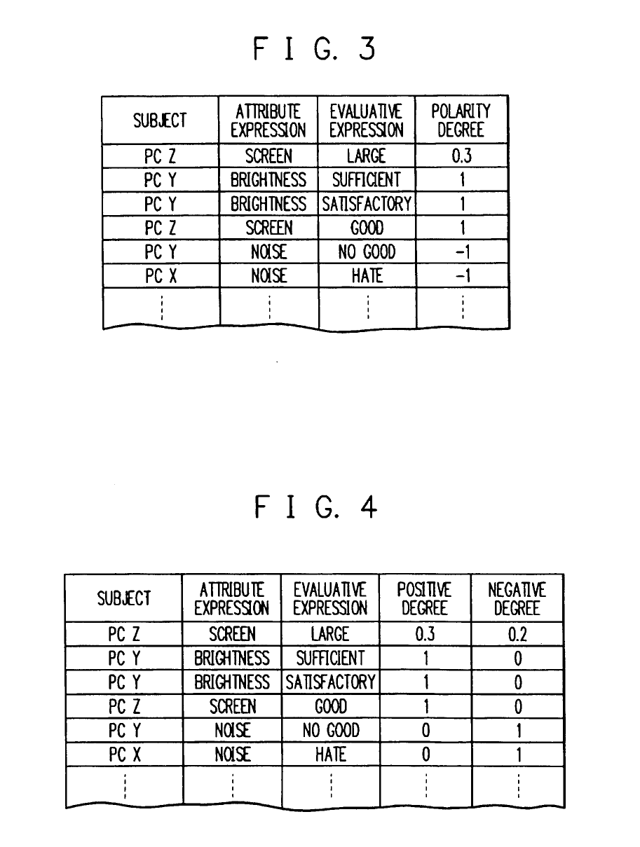

The reputation information storage part 202 stores reputation information and a polarity degree (an evaluation polarity) output by the polarity estimating means 101. FIG. 3 is an explanatory diagram illustrating examples of reputation information and their evaluation polarities stored in the reputation information storage part 202. The reputation information storage part 202 is a database in which reputation information represented by a three-element set of a subject, an attribute expression and an evaluative expression, and a polarity degree of the reputation information are stored correspondingly to each other. It is noted that the reputation information and the polarity degrees stored in the reputation information storage part 202 are updated when necessary on the basis of polarity degrees output by the polarity estimating means 101.

It is noted that the reputation information and the evaluation polarities listed in FIG. 3 are merely exemplarily mentioned, and the reputation information may be represented by a two-element set of a subject and an evaluative expression or a two-element set of an attribute expression and an evaluative expression. Also, a polarity degree may be represented by other numerical values ranging from “100” to “0” or by another method. Also, numerical values may be discretely used and an evaluation polarity may be represented by a symbol such as “∘” or “×”, or an evaluation polarity may be dividedly indicated in a column of a positive degree and a column of a negative degree. FIG. 4 is an explanatory diagram illustrating other examples of the reputation information and the evaluation polarity stored in the reputation information storage part 202. As illustrated in FIG. 4, the reputation information storage part 202 may store, as the evaluation polarity, a positive degree and a negative degree instead of the polarity degree.

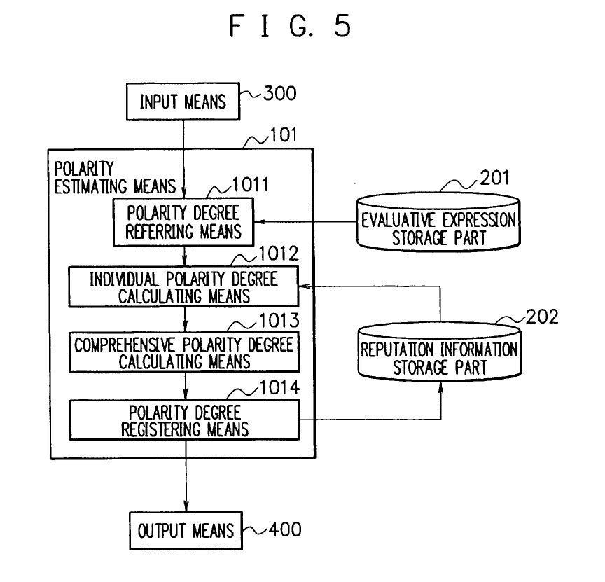

The polarity estimating means 101 has a function to receive reputation information as an input and to output a polarity degree of the input reputation information. FIG. 5 is a block diagram illustrating an exemplary structure of the polarity estimating means 101. As illustrated in FIG. 5, the polarity estimating means 101 includes a polarity degree referring means 1011, an individual polarity degree calculating means 1012, a comprehensive polarity degree calculating means 1013 and a polarity degree registering means 1014.

The polarity degree referring means 1011 has a function to receive (as an input) the reputation information from the input means 300 and to determine through search whether or not an evaluative expression included in the input reputation information is stored in the evaluative expression storage part 201. Also, the polarity degree referring means 1011 has a function, exhibited when it is determined that any of the reputation information stored in the evaluative expression storage part 201 includes an evaluative expression according with that included in the reputation information, to extract, from the evaluative expression storage part 201, a polarity degree of the according evaluative expression. It is noted that a polarity degree extracted by the polarity degree referring means 1011 from the evaluative expression storage part 201 is sometimes designated as an evaluative expression polarity degree.

The individual polarity degree calculating means 1012 has a function to receive the reputation information as an input and to obtain a polarity degree by referring to the reputation information storage part 202. In this case, the individual polarity degree calculating means 1012 calculates a polarity degree with respect to each of a subject, an attribute expression and an evaluative expression. Also, the individual polarity degree calculating means 1012 calculates a polarity degree with respect to every set of two or all of the subject, the attribute expression and the evaluative expression.

Hereinafter, for the sake of explanation, a polarity degree obtained with respect to each of a subject, an attribute expression and an evaluative expression and a polarity degree obtained with respect to each set of two or all of a subject, an attribute expression and an evaluative expression are generically designated as individual polarity degrees.

The individual polarity degree calculating means 1012 calculates a polarity degree of a subject as follows: The individual polarity degree calculating means 1012 refers to the reputation information storage part 202 so as to extract, from the reputation information storage part 202, polarity degrees of all records of reputation information including the subject to be calculated for the polarity degree. Then, the individual polarity degree calculating means 1012 calculates the polarity degree of the subject by obtaining an average of the extracted polarity degrees.

Also in the case where a polarity degree of an attribute expression or an evaluative expression or a polarity degree of a set of two or all of a subject, an attribute expression and an evaluative expression is to be obtained, the polarity degree can be obtained in the same manner as in the case where a polarity degree of a subject is to be obtained. Specifically, the individual polarity degree calculating means 1012 refers to the reputation information storage part 202 so as to extract, from the reputation information storage part 202, polarity degrees of all records of reputation information including, an attribute expression or an evaluative expression, or a set of two or all of a subject, an attribute expression and an evaluative expression to be calculated for the polarity degree. Then, the individual polarity degree calculating means 1012 obtains the polarity degree by obtaining an average of the extracted polarity degrees.

The aforementioned calculation method for a polarity degree is merely exemplarily described, and the individual polarity degree calculating means 1012 may obtain a polarity degree by obtaining a sum of the polarity degrees extracted from the reputation information storage part 202.

Alternatively, the individual polarity degree calculating means 1012 may obtain, as a polarity degree, a ratio or a probability of reputation information with polarity degrees exceeding a given value or reputation information with polarity degrees below a given value on the basis of the amount of reputation information with polarity degrees exceeding the given value and the amount of reputation information with polarity degrees below the given value. In this case, the individual polarity degree calculating means 1012 first extracts, from the reputation information stored in the reputation information storage part 202, primarily all records of reputation information according with input reputation information to be evaluated. Next, the individual polarity degree calculating means 1012 secondarily selects, from the primarily extracted reputation information, reputation information having a polarity degree exceeding a given value (of, for example, 0.3). Then, the individual polarity degree calculating means 1012 obtains a ratio of the number of records of the secondarily selected reputation information (namely, the number of records of reputation information with positive polarities) to the number of records of the primarily extracted reputation information. Alternatively, the individual polarity degree calculating means 1012 secondarily selects, from the primarily extracted reputation information, reputation information having a polarity degree below a given value (of, for example, 0.3). Then, the individual polarity degree calculating means 1012 obtains a ratio of the number of records of the secondarily selected reputation information (namely, the number of records of reputation information with negative polarities) to the number of records of the primarily extracted reputation information.

When the aforementioned structure is employed, even when the information stored in a database included in the evaluation polarity estimation system (that is, the reputation information and the polarity degrees stored in the reputation information storage part 202 in this exemplary embodiment) is biased, the polarity determination can be more accurately performed.

Furthermore, in the case where the reputation information stored in the reputation information storage part 202 is represented by a two-element set of a subject and an evaluative expression or a two-element set of an attribute expression and an evaluative expression, the individual polarity degree calculating means 1012 may calculate a polarity degree of merely calculable one of the two elements of the reputation information (namely, two elements out of a subject, an attribute expression and an evaluative expression). For example, in the case where the reputation information storage part 202 precedently stores reputation information including a subject and an evaluative expression alone, the individual polarity degree calculating means 1012 cannot calculate an individual polarity degree of an attribute expression even if the input reputation information to be evaluated includes an attribute expression. Accordingly, in this case, the individual polarity degree calculating means 1012 obtains merely an individual polarity degree of a subject or an evaluative expression or an individual polarity degree of a set of a subject and an evaluative expression.

The comprehensive polarity degree calculating means 1013 has a function to receive, as inputs, a polarity degree (an evaluative expression polarity degree) extracted by the polarity degree referring means 1011 and individual polarity degrees calculated by the individual polarity degree calculating means 1012 and to calculate a polarity degree (hereinafter sometimes referred to as a comprehensive polarity degree) obtained by integrating the input evaluative expression polarity degree and individual polarity degrees. In this case, the comprehensive polarity degree calculating means 1013 calculates a comprehensive polarity degree by, for example, adding an average of respective polarity degrees (respective individual polarity degrees) calculated by the individual polarity degree calculating means 1012 to the polarity degree extracted by the polarity degree referring means 1011.

It is noted that the aforementioned calculation method for a comprehensive polarity degree is merely exemplarily described, and the comprehensive polarity degree calculating means 1013 may obtain a comprehensive polarity degree by, for example, obtaining an average of the evaluative expression polarity degree and the respective individual polarity degrees. Alternatively, the comprehensive polarity degree calculating means 1013 may obtain a comprehensive polarity degree by, for example, obtaining a sum of the evaluative expression polarity degree and the respective individual polarity degrees. Alternatively, the comprehensive polarity degree calculating means 1013 may obtain a comprehensive polarity degree by giving a prescribed weight to the evaluative expression polarity degree or each individual polarity degree. For example, the comprehensive polarity degree calculating means 1013 may obtain a comprehensive polarity degree with a larger weight given to (specifically, by multiplying by a weight coefficient with a larger value) an individual polarity degree of reputation information having all the elements of a subject, an attribute expression and an evaluative expression according with those of the input reputation information to be evaluated.

The polarity degree registering means 1014 has a function to store the reputation information to be evaluated and the polarity degree (the comprehensive polarity degree) calculated by the comprehensive polarity degree calculating means 1013 correspondingly to each other in the reputation information storage part 202.

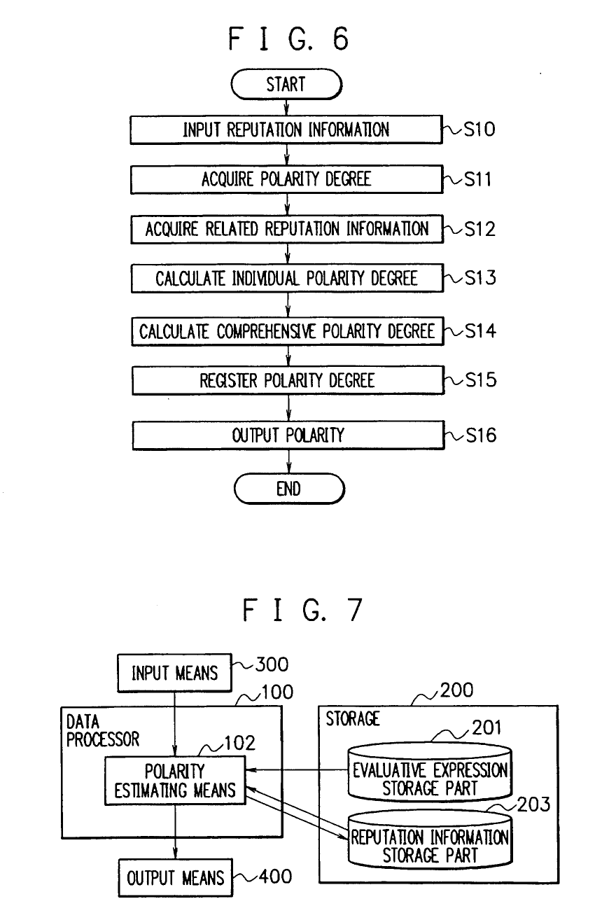

Next, an operation will be described. FIG. 6 is a flowchart illustrating an exemplary process for estimating an evaluation polarity by the evaluation polarity estimation system. First, the data processor 100 of the evaluation polarity estimation system inputs reputation information to be evaluated through the input means 300 in accordance with an operation performed by a user (step S10).

In this exemplary embodiment, the reputation information is information represented by a three-element set of a subject, an attribute expression and an evaluative expression. For example, information represented by a three-element set, such as reputation information [PC X, noise, hate] or reputation information [PC X, noise, large], is input.

In this exemplary embodiment, reputation information is expressed in square brackets. In this case, three elements punctuated with commas respectively corresponds to a subject, an attribute expression and an evaluative expression. It is noted that reputation information may exclude any of a subject and an attribute expression.

The data processor 100 passes the input reputation information to be evaluated to the polarity degree referring means 1011 of the polarity estimating means 101.

Next, the polarity degree referring means 1011 acquires (extracts) a polarity degree of the evaluative expression included in the reputation information to be evaluated from the evaluative expression storage part 201 by referring to the evaluative expression storage part 201 (step S11).

It is herein assumed that the evaluative expression storage part 201 stores the evaluative expressions and the polarity degrees illustrated in FIG. 2. In this case, when the polarity degree referring means 1011 receives (as an input) reputation information [PC X, noise, hate], it refers to the evaluative expression storage part 201, so as to acquire (extract) a polarity degree of “−1” corresponding to the evaluative expression “hate”.

When reputation information [PC X, noise, large] is received (as an input) as the reputation information to be evaluated, the polarity degree referring means 1011 sets a polarity degree to “0” because the evaluative expression “large” is not included in the evaluative expressions stored in the evaluative expression storage part 201. It is noted that a polarity degree of “0” means that the evaluation polarity is unknown.

The polarity estimating means 101 stores the polarity degree extracted by the polarity degree referring means 1011 in a storage unit such as a memory, and passes the reputation information to be evaluated input through the input means 300 to the individual polarity degree calculating means 1012.

Next, the individual polarity degree calculating means 1012 receives (as an input) the reputation information to be evaluated and refers to the reputation information storage part 202, so as to acquire (extract) all records of reputation information and polarity degrees related to the input reputation information (step S12). For example, when the reputation information [PC X, noise, large] is received (as an input), the individual polarity degree calculating means 1012 refers to the reputation information storage part 202, so as to acquire (extract) all records of reputation information including the subject “PC X”, the attribute expression “noise” and the evaluative expression “large” and corresponding polarity degrees from the reputation information storage part 202. Assuming that the reputation information storage part 202 stores the reputation information and the polarity degrees illustrated in FIG. 3, the individual polarity degree calculating means 1012 acquires (extracts) subjects, attribute expressions, evaluative expressions and polarity degrees stored as the 1st, 5th and 6th records.

Next, the individual polarity degree calculating means 1012 calculates one of or a plurality of polarity degrees of the subject, the attribute expression and the evaluative expression or a set of two or all of the subject, the attribute expression and the evaluative expression on the basis of the reputation information to be evaluated input in step S10 (hereinafter sometimes referred to as the input reputation information) and the reputation information and the corresponding polarity degrees acquired (extracted) in step S12 (step S13).

For example, when the input reputation information is [PC X, noise, large], one of or a plurality of polarity degrees of the subject “PC X”, the attribute expression “noise”, the evaluative expression “large”, the set of the subject and the evaluative expression “PC X—large”, the set of the attribute expression and the evaluative expression “noise—large”, and the set of the subject, the attribute expression and the evaluative expression “PC X—noise—large” are calculated. For example, the individual polarity degree calculating means 1012 calculates the polarity degree of the subject, the polarity degree of the attribute expression and the polarity degree of the evaluative expression. In the case where the polarity degree of the subject “PC X” is to be obtained, the individual polarity degree calculating means 1012 calculates the individual polarity degree by obtaining an average of polarity degrees of records of reputation information including the “PC X” as the subject out of the reputation information acquired (extracted) in step S12. In this case, specifically, the individual polarity degree calculating means 1012 calculates the polarity degree (the individual polarity degree) of the subject in accordance with the following Expression (1):

Polarity of Subject=1/Np×ΣPi(i=1−Np) Expression (1)

In this expression, Np indicates the number of records of reputation information including the subject, and Pi indicates the polarity degree of each record of the reputation information including the subject.

Assuming that the number of records of reputation information including the subject “PC X” is “5” and that a sum of the polarity degrees of these records of the reputation information including the subject “PC X” is “−1.5”, the individual polarity degree calculating means 1012 obtains the polarity degree as “−0.3”. Similarly, the individual polarity degree calculating means 1012 calculates the polarity degrees of the attribute expression “noise” and the evaluative expression “large” by obtaining averages of the polarity degrees of the reputation information respectively including these expressions.

Furthermore, in the case where the polarity degree of the set of the subject and the evaluative expression “PC X—large” is to be obtained, the individual polarity degree calculating means 1012 calculates the individual polarity by obtaining an average of polarity degrees of records of reputation information including both the subject “PC X” and the evaluative expression “large”. Similarly, in the case where the polarity degree of the set of the attribute expression and the evaluative expression “noise—large” or the polarity degree of the set of the subject, the attribute expression and the evaluative expression “PC X—noise—large” is to be obtained, the individual polarity degree calculating means 1012 calculates the individual polarity degree by obtaining an average of the polarity degrees of records of reputation information including all the subject “PC X”, the attribute expression “noise” and the evaluative expression “large”.

It is noted that the aforementioned calculation method for an individual polarity degree is merely exemplarily described, and the individual polarity degree calculating means 1012 may obtain an individual polarity degree by, for example, obtaining a sum of polarity degrees extracted from the reputation information storage part 202. Alternatively, the individual polarity degree calculating means 1012 may obtain, as a polarity degree, a ratio or a probability of reputation information with a polarity degree exceeding a given value or reputation information with a polarity degree below a given value on the basis of the amount of reputation information with polarity degrees exceeding the given value and the amount of reputation information with polarity degrees below the given value. Alternatively, when the reputation information stored in the reputation information storage part 202 is represented by a two-element set of a subject and an evaluative expression or a two-element set of an attribute expression and an evaluative expression, the individual polarity degree calculating means 1012 may calculate a polarity degree of merely calculable one of the two elements of the reputation information (namely, any two of the subject, the attribute expression and the evaluative expression).

Moreover, there is no need for the individual polarity degree calculating means 1012 to calculate all the individual polarity degrees of the subject, the attribute expression, the evaluative expression, and the sets each of two or all of the subject, the attribute expression and the evaluative expression. In this exemplary embodiment, the individual polarity degrees are seven in kinds, that is, the polarity degree of a subject, the polarity degree of an attribute expression, the polarity degree of an evaluative expression, the polarity degree of a set of a subject and an attribute expression, the polarity degree of a set of a subject and an evaluative expression, the polarity degree of a set of an attribute expression and an evaluative expression and the polarity degree of a set of a subject, an attribute expression and an evaluative expression. In this case, the individual polarity degree calculating means 1012 may calculate, for example, three polarity degrees, that is, the polarity degree of a subject, the polarity degree of an attribute expression and the polarity degree of an evaluative expression.

Then, the individual polarity degree calculating means 1012 passes the calculated individual polarity degrees to the comprehensive polarity degree calculating means 1013.

Next, the comprehensive polarity degree calculating means 1013 receives, as inputs, the polarity degree (the evaluative expression polarity degree) acquired (extracted) in step S11 and the individual polarity degrees calculated in step S13, and calculates a polarity degree (a comprehensive polarity degree) by comprehensively integrating the evaluative expression polarity degree and the individual polarity degrees (step S14). In obtaining a united polarity degree (a comprehensive polarity degree), for example, the comprehensive polarity degree calculating means 1013 adds an average value of the individual polarity degrees calculated in step S12 to the polarity degree acquired in step S11.

It is assumed that the polarity degree acquired in step S11 is, for example, “0”. It is also assumed, in the individual polarity degrees calculated in step S12, that the polarity degree of the subject is “−0.3”, the polarity degree of the attribute expression is “−0.8” and the polarity degree of the evaluative expression is “0.2”. In this case, an average of the individual polarity degrees obtained in step S12 is “−0.3”. Accordingly, the comprehensive polarity degree calculating means 1013 calculates the united polarity degree (the comprehensive polarity degree) as “−0.3”.

Although the aforementioned calculation method is employed in this exemplary embodiment on the basis of an approach that the polarity degree of an evaluative expression is corrected by individual polarity degrees, the calculation method for a comprehensive polarity degree described in this exemplary embodiment is merely exemplarily mentioned, and a comprehensive polarity degree may be obtained by simply obtaining an average or a sum of the evaluative expression polarity degree and the individual polarity degrees.

Next, the polarity degree registering means 1014 registers the input reputation information input in step S10 and the polarity degree (the comprehensive polarity degree) calculated in step S14 additionally in the reputation information storage part 202 (step S15). In this case, the polarity degree registering means 1014 makes the reputation information storage part 202 store the reputation information and the polarity degree correspondingly to each other. For example, when the reputation information is [PC X, noise, large] and the polarity degree is “−0.3”, the polarity degree registering means 1014 newly adds a record including them as elements.

Next, the polarity estimating means 101 makes the output means 400 output the polarity degree (step S16). For example, the polarity estimating means 101 may make it output a numerical value of “−0.3” or the like, a symbol “∘” when the obtained polarity degree is a value exceeding a given threshold value, or a symbol “×” when the obtained polarity degree is a value below the threshold value. Alternatively, the individual polarity degrees calculated in step S13 may be output. The output means 400 outputs (for example, displays) the polarity degree in response to an instruction issued by the polarity estimating means 101.

In this manner, according to the exemplary embodiment, an evaluation polarity degree is calculated with respect to each of a subject, an attribute expression, an evaluative expression or a set of them included in reputation information with known polarity (namely, reputation information precedently stored). Also, an evaluation polarity degree is output by making reference to a subject, an attribute expression and an evaluative expression included in reputation information with an unknown evaluation polarity. Therefore, with respect to reputation information with an unknown evaluation polarity, the evaluation polarity may be estimated by using reputation information with a known evaluation polarity.

Specifically, the polarity estimating means 101 can estimate an evaluation polarity based on not only the polarity of an evaluative expression but also reputation information with a known polarity in consideration of use of an expression with good impression or bad impression as an attribute expression and a positive degree or a negative degree of a subject. Therefore, the polarity of an evaluative expression with an unknown evaluation polarity can be estimated. In other words, an evaluation polarity can be estimated on the basis of reputation information precedently stored in consideration of bias in polarity degrees of a subject, an attribute expression and an evaluative expression, resulting in reducing a situation where the evaluation polarity cannot be determined.

Furthermore, although it is frequently impossible to determine a polarity on the basis of an evaluative expression alone in the conventional evaluation polarity estimation system because the polarity of reputation information is determined on the basis of merely a polarity of an evaluative expression, the situation where the evaluation polarity cannot be determined can be reduced by employing the aforementioned structure.

Moreover, according to the present exemplary embodiment, the polarity estimating means 101 successively stores calculation results for calculated polarity degrees in the reputation information storage part 202. The polarity estimating means 101 uses the results of the polarity degrees stored in the reputation information storage part 202 in calculation of a polarity degree performed subsequently. Therefore, although the accuracy of calculation of polarity degrees is rather poor at the beginning of the use of the present system, the accuracy of calculation of polarity degrees can be improved as the calculation results of polarity degrees are repeatedly accumulated and the amount of stored reputation information is increased.

### Exemplary Embodiment 2

Exemplary embodiment 2 of the invention will now be described with reference to the accompanying drawings. FIG. 7 is a block diagram illustrating an exemplary structure of a polarity estimation system (an evaluation polarity estimation system) according to exemplary embodiment 2. As illustrated in FIG. 7, the content of information stored in a reputation information storage part 203 is different from that stored in the reputation information storage part 203 of exemplary embodiment 1. Also, the function of a polarity estimating means 102 of this exemplary embodiment is different from that of the polarity estimating means 101 described in exemplary embodiment 1. The functions of components other than the polarity estimating means 102 and the reputation information storage part 203 are the same as those described in exemplary embodiment 1.

In the following description, detailed description of similarity to the structure of Exemplary embodiment 1 will be omitted and differences from Exemplary embodiment 1 will be mainly described.

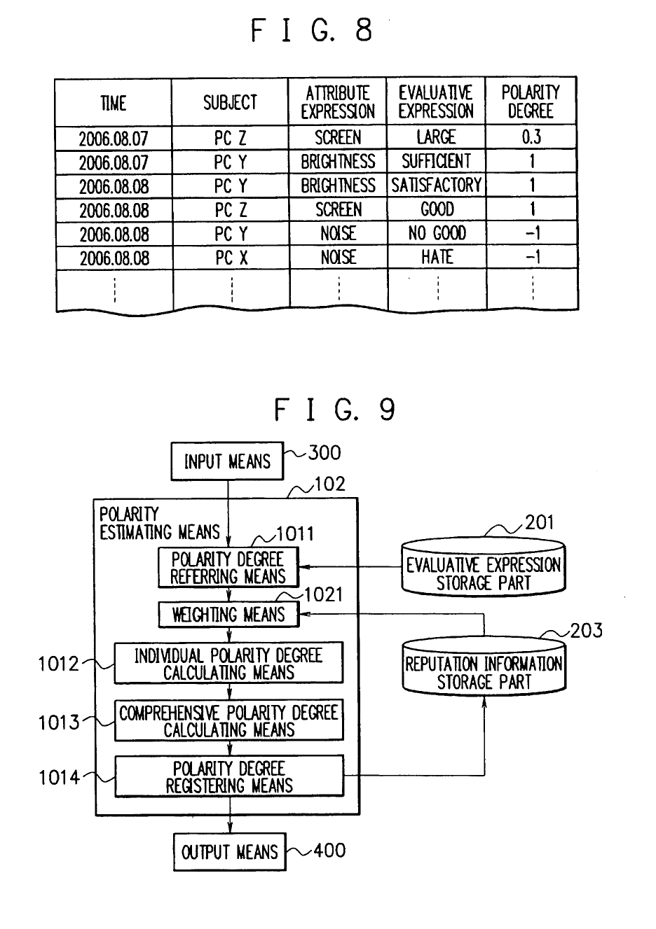

The reputation information storage part 203 stores reputation information, a date of acquirement of the reputation information, and a polarity degree (an evaluation polarity) of the reputation information. FIG. 8 is an explanatory diagram illustrating examples of the reputation information, the data of acquirement and the evaluation polarity stored in the reputation information storage part 203. The reputation information storage part 203 is a database storing, as one record, time (a date of acquirement in this exemplary embodiment) when reputation information was acquired, a subject, an attribute expression, an evaluative expression and a polarity degree. In other words, the reputation information storage part 203 of this exemplary embodiment stores reputation information (including a subject, an attribute expression and an evaluative expression), a date of acquirement when the reputation information was acquired and an evaluation polarity of the reputation information correspondingly to one another.

A date of acquirement of reputation information is obtained, in registering the reputation information in the reputation information storage part 203, for example, on the basis of a time signal output by a timer included in the data processor 100, and the data processor 100 stores the obtained date of acquirement in the reputation information storage part 203 correspondingly to the reputation information.

In this exemplary embodiment, a polarity degree is a value ranging from “1” to “−1”, and as a polarity degree is closer to “1”, the evaluative expression is more positive. As a polarity degree is closer to “−1”, the evaluative expression is more negative. It is noted that the time listed in FIG. 8 is illustrated as a date.

It is noted that the reputation information and the evaluation polarities listed in FIG. 8 are merely exemplarily mentioned, and reputation information may be represented by a two-element set of a subject and an evaluative expression or a two-element set of an attribute expression and an evaluative expression. Also, numerical values may be discretely used and an evaluation polarity may be represented by a symbol such as “∘” or “×“, or an evaluation polarity may be dividedly indicated in a column of a positive degree and a column of a negative degree. The time corresponding to a date of acquirement of reputation information may be information other than the date, and may include, for example, an hour when the reputation information was acquired or may be information including a year and a month alone.

In this exemplary embodiment, the polarity estimating means 102 receives, as an input, reputation information to be evaluated and is different from that of Exemplary embodiment 1 in calculating and outputting a polarity degree obtained by weighting a polarity degree of recent reputation information out of precedently stored reputation information.

FIG. 9 is a block diagram illustrating an exemplary structure of the polarity estimating means 102 of Exemplary embodiment 2. As illustrated in FIG. 9, the polarity estimating means 102 of this exemplary embodiment is different from that of Exemplary embodiment 1 in including weighting means 1021 in addition to the components of the polarity estimating means 101 of FIG. 5.

The weighting means 1021 has a function to receive the reputation information to be evaluated as an input and to refer to the reputation information storage part 203 so as to acquire (extract) related reputation information, time (a date of acquirement of the reputation information) and polarity degree from the reputation information storage part 203. For example, the weighting means 1021 extracts, from the reputation information storage part 203, all records of reputation information including elements (i.e., a subject, an attribute expression and an evaluative expression) according with those included in the reputation information to be evaluated, and extracts the time (the date of acquirement) and the polarity degree corresponding to each extracted records of the reputation information.

Furthermore, the weighting means 1021 has a function to calculate a polarity degree with a larger weight given to recent reputation information out of the extracted reputation information (which polarity degree is sometimes referred to as the weighted polarity degree) and to pass the reputation information and the weighted polarity degree to the individual polarity degree calculating means 1012. For example, the weighting means 1021 selects, on the basis of the time of extraction (date of acquirement), reputation information whose date of acquirement falls within several days from the current date out of the extracted reputation information. Then, the weighting means 1021 weights the polarity degree of the selected reputation information (by, for example, multiplying a prescribed weight coefficient), and obtains a weighted polarity degree by using the polarity degree thus weighted.

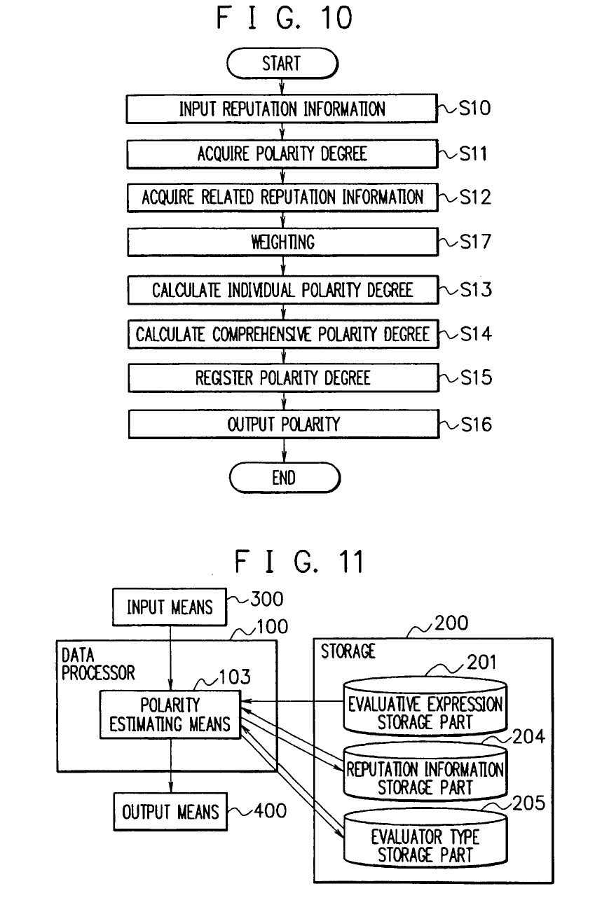

Next, an operation will be described. FIG. 10 is a flowchart illustrating an exemplary process for estimating an evaluation polarity by the evaluation polarity estimation system of Exemplary embodiment 2. As illustrated in FIG. 10, the process of this exemplary embodiment is different from that of Exemplary embodiment 1 in performing weighting processing (step S17) additionally to the processing of FIG. 6.

In the following description, detailed description of similarity to the process of Exemplary embodiment 1 will be omitted and differences from Exemplary embodiment 1 will be mainly described.

First, the data processor 100 of the evaluation polarity estimation system inputs reputation information to be evaluated through the input means 300 in accordance with an operation performed by a user (step S10). The data processor 100 passes the input reputation information to be evaluated to the polarity degree referring means 1011 of the polarity estimating means 102.

Next, the polarity degree referring means 1011 refers to the evaluative expression storage part 201 so as to acquire (extract) a polarity degree of an evaluative expression included in the input reputation information from the evaluative expression storage part 201 (step S11). The polarity estimating means 102 stores the polarity degree extracted by the polarity degree referring means 1011 in a storage unit such as a memory, and passes the reputation information to be evaluated input through the input means 300 to the weighting means 1021.

Then, the weighting means 1021 receives (as an input) the input reputation information input in step S10, and refers to the reputation information storage part 203 so as to acquire (extract) all related records of reputation information, and times (dates of acquirement of the reputation information) and polarity degrees from the reputation information storage part 203 (step S12). For example, when the weighting means 1021 receives (as an input) input reputation information [PC X, noise, large], it refers to the reputation information storage part 203, and in the case where it stores eight records of reputation information including the subject “PC X”, the attribute expression “noise” and the evaluative expression “large”, the subjects, the attribute expressions, the evaluative expressions, the times and the polarity degrees of all the eight records are acquired (extracted) from the reputation information storage part 203.

Next, the weighting means 1021 calculates a polarity degree with a large weight given to recent reputation information out of the extracted records of the reputation information (step S17). For example, the weighting means 1021 multiplies a polarity degree of reputation information acquired in a prescribed period of time (for example, within the recent three months) by a weight of 1, and multiplies another polarity degree by a weight of 0. For example, in the case where the subject is a PC, the model is changed quarterly, and hence, reputation information evaluated within the recent three months alone is used for obtaining a polarity degree. This is merely an example, and the weight may be changed per month, or a time difference between the current time and the time of acquirement of reputation information is calculated so as to use an inverse of the calculated time difference as a weight coefficient to multiply the polarity degree.

Then, the weighting means 1021 passes the reputation information to be evaluated and the obtained weighted polarity degree to the individual polarity degree calculating means 1012.

Next, the individual polarity degree calculating means 1012 calculates, on the basis of the input reputation information input in step S10 and the reputation information extracted and the weighted polarity degree calculated in step S17, a polarity degree of the subject, the attribute expression or the evaluative expression or a set of two or all of the subject, the attribute expression and the evaluative expression (step S13).

Then, the comprehensive polarity degree calculating means receives, as inputs, the polarity degree (the evaluative expression polarity degree) acquired (extracted) in step S11 and the individual polarity degrees calculated in step S13, and calculates a polarity degree (a comprehensive polarity degree) by comprehensively integrating the evaluative expression polarity degree and the individual polarity degrees (step S14).

Thereafter, the polarity degree registering means 1014 additionally registers the input reputation information input in step S10, the polarity degree (the comprehensive polarity degree) calculated in step S14 and the current time in the reputation information storage part 203 (step S15). In this case, the polarity degree registering means 1014 stores the reputation information, the polarity degree and the current time correspondingly to one another in the reputation information storage part 203.

Next, the polarity estimating means 101 makes the output means 400 output the polarity degree (step S16).

The aforementioned structure for weighting is merely exemplarily described, and for example, the individual polarity degree calculating means 1012 may be provided with a function substantially the same as that of the weighting means as its function. In other words, the structure for weighting is not limited to that described above.

In this manner, according to the exemplary embodiment, the weighting means 1021 calculates a polarity degree with a larger weight given to a polarity degree of recent reputation information. Therefore, in addition to the effects described in Exemplary embodiment 1, a polarity of reputation information can be estimated in consideration of change with time of the reputation information.

### Exemplary Embodiment 3

Exemplary embodiment 3 of the invention will now be described with reference to the accompanying drawings. FIG. 11 is a block diagram illustrating an exemplary structure of a polarity estimation system (an evaluation polarity estimation system) according to Exemplary embodiment 3. As illustrated in FIG. 11, the content of information stored in a reputation information storage part 204 of this exemplary embodiment is different from that stored in the reputation information storage part 202 of Exemplary embodiment 1. Also, the function of a polarity estimating means 103 of this exemplary embodiment is different from that of the polarity estimating means 101 of Exemplary embodiment 1. Furthermore, a storage 200 of this exemplary embodiment is different from that of Exemplary embodiment 1 in including an evaluator type storage part 205 in addition to the components illustrated in FIG. 1. It is noted that the functions of the components other than the polarity estimating means 103, the reputation information storage part 204 and the evaluator type storage part 205 are the same as those described in Exemplary embodiment 1.

In the following description, detailed description of similarity to the structure of Exemplary embodiment 1 will be omitted and differences from Exemplary embodiment 1 will be mainly described.

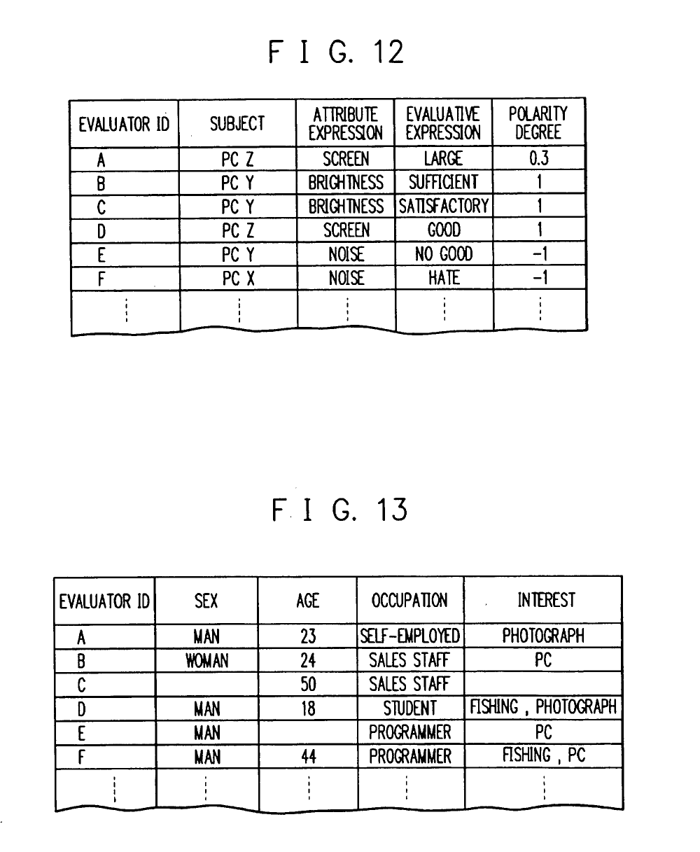

The reputation information storage part 204 stores reputation information, an evaluator ID for identifying an evaluator having evaluated the reputation information and a polarity degree (an evaluation polarity) of the reputation information. FIG. 12 is an explanatory diagram illustrating examples of the reputation information, the evaluator ID and the evaluation polarity stored in the reputation information storage part 204. The reputation information storage part 204 is a database storing, as one record, an evaluator ID of an evaluator having entered evaluation of the reputation information, a subject, an attribute expression, an evaluative expression and a polarity degree. In other words, in this exemplary embodiment, the reputation information storage part 204 stores reputation information (including a subject, an attribute expression and an evaluative expression), an evaluator ID of an evaluator having evaluated the reputation information and an evaluation polarity of the reputation information correspondingly to one another.

An evaluator ID is stored in the reputation information storage part 204 correspondingly to reputation information by the data processor 100 in registering the reputation information in the reputation information storage part 204.

In this exemplary embodiment, a polarity degree is represented by numerical values ranging from “1” to “−1”, and as a polarity degree is closer to “1”, the corresponding evaluative expression is more positive. On the other hand, as a polarity degree is closer to “−1”, the corresponding evaluative expression is more negative. It is noted that an evaluator ID stored in the reputation information storage part 204 as illustrated in FIG. 12 corresponds to an evaluator ID stored in the evaluator type storage part 205 described below.

It is noted that the reputation information and the evaluation polarities listed in FIG. 12 are merely exemplarily mentioned, and reputation information may be represented by a two-element set of a subject and an evaluative expression or a two-element set of an attribute expression and an evaluative expression. Also, numerical values may be discretely used and an evaluation polarity may be represented by a symbol such as “∘” or “×”, or an evaluation polarity may be dividedly indicated in a column of a positive degree and a column of a negative degree. Also, a polarity degree is represented by another method as described above.

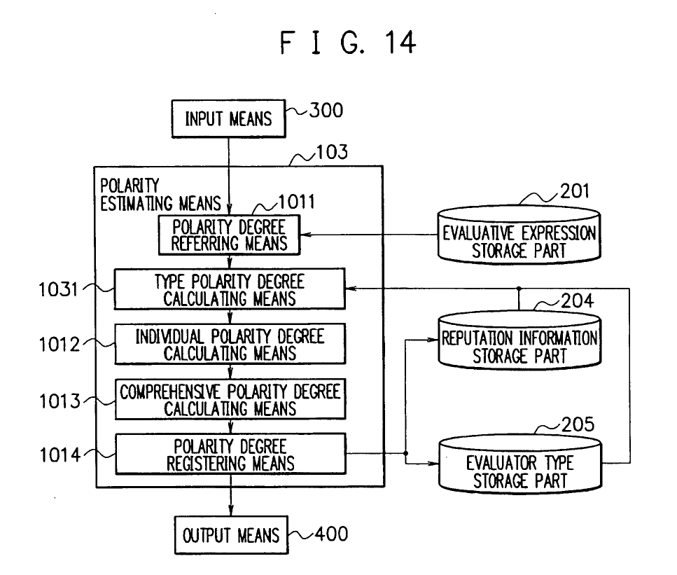

The evaluator type storage part 205 stores evaluator type information corresponding to information representing the type of an evaluator. FIG. 13 is an explanatory diagram illustrating examples of the evaluator type information stored in the evaluator type storage part 205. The evaluator type storage part 205 is a database storing, as one record, an evaluator ID, a sex, an age, an occupation and an interest of an evaluator with the evaluator ID. In other words, according to this exemplary embodiment, the evaluator type storage part 205 stores, correspondingly to an evaluator ID of an evaluator, a sex, an age, an occupation and an interest as the type items of the evaluator.

It is noted that an empty cell of FIG. 13 means that the corresponding type item is unknown. Also, items listed in a cell of the interest are punctuated with a “comma”, which means that the evaluator type storage part 205 can store a plurality of interests correspondingly to each evaluator.

Also, the evaluator type information listed in FIG. 13 is merely exemplarily mentioned, and the evaluator type storage part may store other information such as a purchased product history as the evaluator type information.

In this exemplary embodiment, the polarity estimating means 103 has a function to receive, as inputs, reputation information to be evaluated and an evaluator type of an evaluator having evaluated the reputation information, and to calculate a polarity degree with respect to each evaluator type item so as to output a polarity degree in consideration of bias derived from the evaluator type in addition to the functions described in Exemplary embodiment 1.

FIG. 14 is a block diagram illustrating an exemplary structure of the polarity estimating means 103 of Exemplary embodiment 3. As illustrated in FIG. 14, the polarity estimating means 103 of this exemplary embodiment is different from that of Exemplary embodiment 1 in including a type polarity degree calculating means 1031 in addition to the components of the polarity estimating means 101 of FIG. 5. It is noted that the order of the type polarity degree calculating means 1031 and the individual polarity degree calculating means 1012 may be reversed in the components of the polarity estimating means 103 of FIG. 14.

The type polarity degree calculating means 1031 has a function to receive an evaluator type and reputation information as inputs, and to calculate, by referring to the evaluator type storage part 205 and the reputation information storage part 204, a polarity degree of every set of each evaluator type item such as an age or a sex and the reputation information (which polarity degree is hereinafter sometimes referred to as the evaluator type polarity degree). For example, when the evaluator type items are a sex, an age, an occupation, an interest and a purchased product history, the type polarity degree calculating means 1031 calculates polarity degrees (evaluator type polarity degrees) of a set of a subject and a sex, a set of a subject and an age, a set of a subject and an occupation, a set of a subject and an interest, a set of a subject and a purchased product, and the like. Thus, it can be calculated how evaluators of a similar evaluator type have evaluated the input evaluative expression.

It is assumed, for example, that input evaluator type items are a sex “man”, an age “unknown”, an occupation “unknown” and an interest “PC” and that input reputation information is [PC X, noise, large]. In this case, the type polarity degree calculating means 1031 first determines which sets are to be employed for calculating polarity degrees. It is herein assumed that the polarity degrees of a set of the sex and the subject and a set of the interest and the subject are to be calculated. It is noted that the type polarity degree calculating means 1031 may determine which sets are to be employed for calculating polarity degrees in accordance with an input operation performed by a user or on the basis of set information precedently set.

Next, the type polarity degree calculating means 1031 refers to the evaluator type storage part 205 and the reputation information storage part 204, so as to acquire (extract) all records of reputation information including the sex “man” and the subject “PC X” and polarity degrees corresponding to the records of the reputation information. Then, the type polarity degree calculating means 1031 obtains an average of the extracted polarity degrees. Similarly, the type polarity degree calculating means 1031 acquires (extracts) all records of reputation information including the interest “PC” and the subject “PC X” and polarity degrees corresponding to these records of the reputation information. Then, the type polarity degree calculating means 1031 obtains an average of the extracted polarity degrees.

It is noted that the aforementioned calculation method for a polarity degree is merely exemplarily described, and the type polarity degree calculating means 1031 may obtain a polarity degree of a set of an evaluator type item and another element of the reputation information described in this exemplary embodiment. Alternatively, the type polarity degree calculating means 1031 may calculate a polarity degree by obtaining a sum instead of the average of extracted polarity degrees.

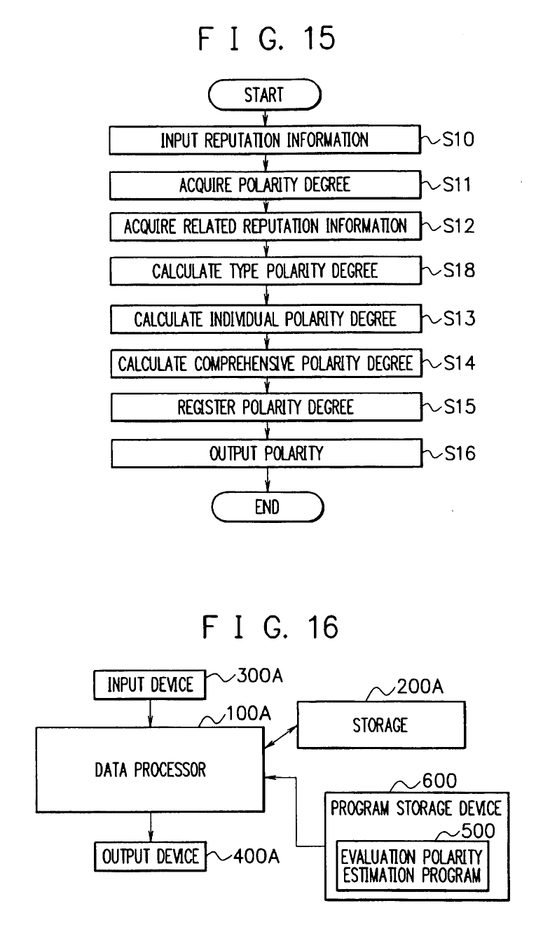

Next, an operation will be described. FIG. 15 is a flowchart illustrating an exemplary process for estimating an evaluation polarity by the evaluation polarity estimation system of Exemplary embodiment 3. As illustrated in FIG. 15, the process of this exemplary embodiment is different from that of Exemplary embodiment 1 in type polarity degree calculation processing (step S18) performed in addition to the other processing illustrated in FIG. 6.

In the following description, detailed description of similarity to the process of Exemplary embodiment 1 will be omitted and differences from Exemplary embodiment 1 will be mainly described. It is noted that the order of executing the type polarity degree calculation processing (step S18) and individual polarity degree calculation processing (step S13) can be reverse in the flowchart of FIG. 15.

First, the data processor 100 of the evaluation polarity estimation system inputs reputation information to be evaluated and an evaluator type through the input means 300 in accordance with an operation performed by a user (step S10). The data processor 100 passes information of the input evaluator type items such as an evaluator ID, a sex, an age, an occupation, an interest and a purchased product history to the type polarity degree calculating means 1031 of the polarity estimating means 103. When the evaluator type storage part 205 precedently stores the information of evaluator types, the data processor 100 passes the evaluator ID alone to the type polarity degree calculating means 1031. Alternatively, when the information of evaluator types is not stored, the data processor 100 inputs the information of the evaluator type to be passed to the type polarity degree calculating means 1031.

For obtaining the information of the evaluator type, when the reputation information is extracted, for example, on the basis of freely filled questionnaires, the evaluator type items may be included as survey items so as to extract the evaluator type information from collated results of the questionnaires. Alternatively, when the reputation information is extracted on the basis of a blog article on the Internet, the evaluator type information may be obtained by an existing method for determining the sex of a writer of an article in accordance with the style of writing.

The data processor 100 passes the input reputation information and evaluator type to the polarity degree referring means 1011 of the polarity estimating means 103.

Next, the polarity degree referring means 1011 refers to the evaluative expression storage part 201, so as to acquire (extract) a polarity degree of an evaluative expression included in the reputation information from the evaluative expression storage part 201 (step S11). The polarity estimating means 103 stores the polarity degree extracted by the polarity degree referring means 1011, the reputation information and the evaluator type in a storage unit of a memory or the like.

Next, the polarity estimating means 103 receives (as inputs) the input reputation information and the input evaluator type input in step S10, and refers to the reputation information storage part 204 and the evaluator type storage part 205, so as to acquire (extract) all related records of reputation information, evaluator type items and polarity degrees from the reputation information storage part 204 and the evaluator type storage part 205 (step S12).

For example, when the polarity estimating means 103 receives (as inputs) input reputation information [PC X, noise, large] and input evaluator type items of a sex “man” and an interest “PC”, it refers to the reputation information storage part 204 and the evaluator type storage part 205, so as to acquire (extract) all records of reputation information including the subject “PC X”, the attribute expression “noise”, the evaluative expression “large”, the sex “man” and the interest “PC”. In this exemplary embodiment, the thus acquired data is a record including a subject, an attribute expression, an evaluative expression, a sex, an interest and a polarity degree. Then, the polarity estimating means 103 passes the acquired records to the type polarity degree calculating means 1031.

Next, the type polarity degree calculating means 1031 calculates a polarity degree (an evaluator type polarity degrees) of every set of each evaluator type item such as an age or a sex and the reputation information (step S18). The type polarity degree calculating means 1031 receives (as inputs) the input reputation information and the input evaluator type input in step S10 and the records acquired in step S12, and calculates a polarity degree of a set of an age and a subject, a polarity degree of a set of an interest and a subject, and the like.

For example, it is assumed that the input evaluator type items are a sex “man”, an age “unknown”, an occupation “unknown” and an interest “PC” and that the reputation information [PC X, noise, large] is received (as an input). In this case, the type polarity degree calculating means 1031 first determines which set is to be employed for calculating a polarity degree. Herein, it is assumed that a set of the sex and the subject and a set of the interest and the subject are employed for calculating polarity degrees.

Next, the type polarity degree calculating means 1031 acquires (extracts), from the records acquired in step S12, all records of reputation information including the sex “man” and the subject “PC X” and polarity degrees corresponding to the records of the reputation information. Then, the type polarity degree calculating means 1031 obtains an average of the extracted polarity degrees. Similarly, the type polarity degree calculating means acquires (extracts) all records of reputation information including the interest “PC” and the subject “PC X” and polarity degrees corresponding to the records of the reputation information. Then, the type polarity degree calculating means 1031 obtains an average of the extracted polarity degrees.

It is noted that the aforementioned calculation method for a polarity degree is merely exemplarily described, and the type polarity degree calculating means 1031 may calculate a polarity degree of a set of an evaluator type item and another element of the reputation information described in this exemplary embodiment. Alternatively, the type polarity degree calculating means 1031 may calculate a polarity degree by obtaining a sum instead of the average of the extracted polarity degrees.

Next, the individual polarity degree calculating means 1012 receives (as inputs) the input reputation information input in step S10 and the records acquired in step S12, and calculates a polarity degree of the subject, the attribute expression or the evaluative expression or a set of two or all of the subject, the attribute expression and the evaluative expression (step S15).

Then, the comprehensive polarity degree calculating means receives, as inputs, the polarity degree (the evaluative expression polarity degree) acquired (extracted) in step S11, the polarity degrees (the evaluator type polarity degrees) of the sets of the evaluator type items and the reputation information calculated in step S18 and the individual polarity degrees calculated in step S13, so as to calculate a polarity degree (a comprehensive polarity degree) by comprehensively integrating the evaluative expression polarity degree, the evaluator type polarity degrees and the individual polarity degrees (step S14). For example, the comprehensive polarity degree calculating means 1013 calculates a united polarity degree (a comprehensive polarity degree) by adding an average of the polarity degrees calculated in step S18 and an average of the individual polarity degrees calculated in step S13 to the polarity degree acquired in step S11.

It is noted that the aforementioned calculation method for a polarity degree is merely exemplarily described, and the comprehensive polarity degree calculating means 1013 may calculate a comprehensive polarity degree by obtaining a sum or an average of the respective polarity degrees.

Next, the polarity degree registering means 1014 additionally registers the input reputation information and the input evaluator type input in step S11 and the polarity degree calculated in step S14 in the reputation information storage part 204 and the evaluator type storage part 205 (step S15). In this case, the polarity degree registering means 1014 stores the reputation information, the polarity degree and the evaluator ID correspondingly to one another in the reputation information storage part 205.

Next, the polarity estimating means 103 makes the output means 400 output the polarity degree (step S16).

In this manner, according to the exemplary embodiment, the type polarity degree calculating means 1031 calculates evaluation tendency of each type of evaluators for calculating an evaluation polarity. Therefore, in addition to the effects described in Exemplary embodiment 1, a polarity of reputation information can be estimated in consideration of bias derived from the type of an evaluator for the reputation information.

Now, specific examples of the architecture of each information extraction system (evaluation polarity estimation system) described in Exemplary embodiments 1 through 3 will be described. FIG. 16 is a block diagram illustrating a specific exemplary architecture of each evaluation polarity estimation system described in the aforementioned exemplary embodiments. As illustrated in FIG. 16, the evaluation polarity estimation system includes a data processor 100A, a storage 200A, an input device 300A, an output device 400A and a program storage device 600. In the exemplary architecture of FIG. 16, the data processor 100 is realized by a computer operated in accordance with a program.

The data processor 100A is connected to the input device 300A such as a keyboard or a mouse and the output device 400A such as a display or a printer. Furthermore, the data processor 100A is connected to the storage 200A. The storage 200A is a device including the evaluative expression storage part 201, the reputation information storage part 202 and the like, and may be connected to the data processor 100A through a bus or the like or through a communication network.

Furthermore, in realizing the evaluation polarity estimation system described in Exemplary embodiment 3, the storage 200A also includes the evaluator type storage part 205.

Furthermore, the data processor 100A is provided with the program storing device (such as a hard disk device or a CD-ROM) 600 storing an evaluation polarity estimation program 500. As the evaluation polarity estimation program 500, the program storing device 600 stores, for example, a polarity estimation program that causes a computer to execute reputation information storing processing for precedently storing reputation information with a known evaluation polarity and polarity estimating processing for estimating an evaluation polarity of reputation information with an unknown polarity on the basis of the precedently stored reputation information with the known evaluation polarity.

The data processor 100A reads the evaluation polarity estimation program 500 from the program storing device 600 so as to operate in accordance with the read evaluation polarity estimation program 500. Through such an operation, the data processor 100A is operated as the polarity estimating means 101, the polarity estimating means 102 or the polarity estimating means 103.

Furthermore, the data processor 100A corresponding to a computer may include a storage unit therein so as to store information (such as input reputation information) in the storage unit.

Moreover, in each of the aforementioned exemplary embodiments, each means (each of the evaluation polarity estimating means 101, the polarity degree referring means 1011, the individual polarity degree calculating means 1012, the comprehensive polarity degree calculating means 1013, the polarity degree registering means 1014, the weighting means 1021 and the type polarity degree calculating means 1031) may be provided in the data processor 100A as separate hardware.

Furthermore, although a keyboard or a mouse is described as an example of the input means 300 in each of the aforementioned exemplary embodiments, reputation information may be input to the evaluation polarity estimation system from another device through a communication network. In this case, a communication interface unit used for communication through the communication network is used as the input means 100. Also, the form of outputting a polarity degree may be a form in which a polarity degree is output to another device through a communication network. Also in this case, a communication interface unit used for communication through the communication network is used as the output means 400.

It is noted that the input means 300 is realized by the input device 300A. Also, the output means 400 is realized by the output device 400A.

### Exemplary Embodiment 4

Exemplary embodiment 4 of the invention will now be described with reference to the accompanying drawings. In this exemplary embodiment, a business model in which any of the evaluation polarity estimation systems described in Exemplary embodiments 1 through 3 is applied to an information service system for delivering reputation information (a reputation information delivery system) will be described.

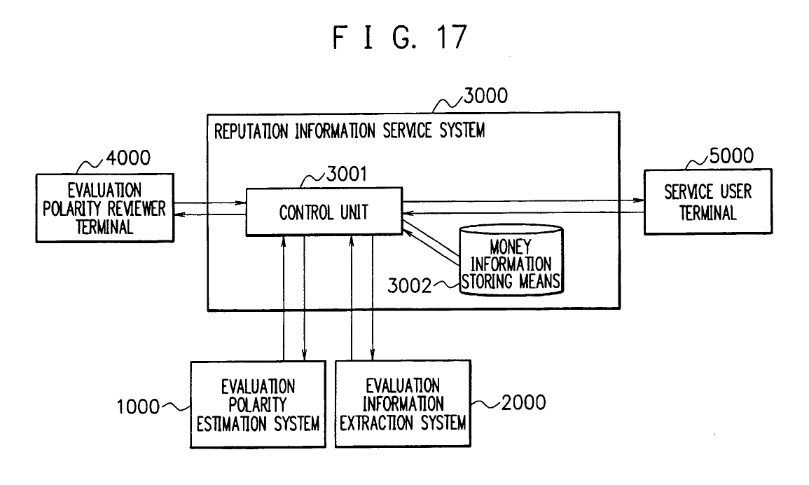

FIG. 17 is a block diagram illustrating an exemplary structure of the information service system according to this invention. The information service system of this exemplary embodiment includes an evaluation polarity estimation system 1000, a reputation information extraction system 2000, a reputation information service system 3000, an evaluation polarity reviewer terminal 4000, and a service user terminal 5000. It is noted that the evaluation polarity estimation system 1000, the reputation information extraction system 2000, the reputation information service system 3000, the evaluation polarity reviewer terminal 4000 and the service user terminal 5000 are connected to one another through, for example, a communication network such as the Internet.

The evaluation polarity estimation system 1000 is operated by, for example, a service operator that provides a reputation information delivery service (hereinafter sometimes referred to as the reputation information service operator). The evaluation polarity estimation system 1000 is specifically realized by an information processor such as a work station or a personal computer operated in accordance with a program. The evaluation polarity estimation system 1000 corresponds to any of the evaluation polarity estimation systems described in Exemplary embodiments 1 through 3.

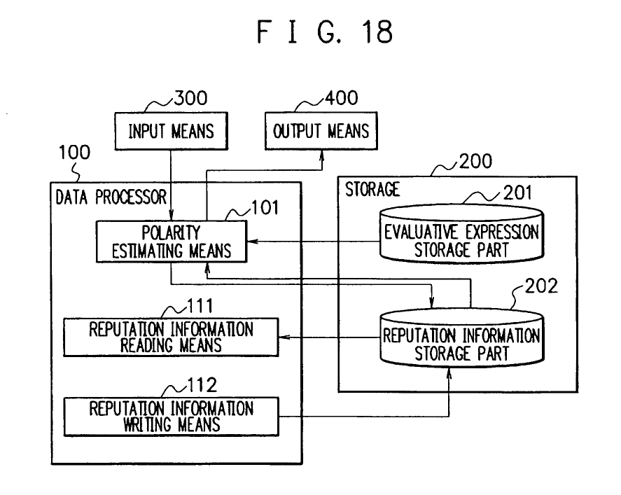

FIG. 18 is a block diagram illustrating an exemplary structure of the polarity estimation system according to Exemplary embodiment 4. In this exemplary embodiment, application of the evaluation polarity estimation system of Exemplary embodiment 1 to the information service system will be described as an example. The evaluation polarity estimation system of this exemplary embodiment is, however, rather different from that described in Exemplary embodiment 1, as illustrated in FIG. 18, in reputation information reading means 111 and reputation information writing means 112 provided additionally to the components described in Exemplary embodiment 1.

Although the evaluation polarity estimation system of Exemplary embodiment 1 is applied to the information service system as an example in FIG. 18, the evaluation polarity estimation system of Exemplary embodiment 2 or 3 may be similarly applied.

The reputation information reading means 111 and the reputation information writing means 112 are specifically realized by a CPU and a network interface unit of the information processor used for realizing the evaluation polarity estimation system 1000 operated in accordance with a program. The reputation information reading means 111 has a function to input (receive) a subject, an attribute expression and an evaluative expression (i.e., reputation information) through a communication network and to read information from a reputation information accumulation part included in the evaluation polarity estimation system 1000 (i.e., the reputation information storage part 202). The reputation information writing means 112 has a function to input (receive) a subject, an attribute expression, an evaluative expression and a polarity degree through the communication network and to write such input information in the reputation information accumulation part included in the evaluation polarity estimation system 1000 (i.e., the reputation information storage part 202).

The reputation information extraction system 2000 is operated by, for example, a reputation information service operator and is specifically realized by an information processor such as a work station or a personal computer operated in accordance with a program. The reputation information extraction system 2000 has a function to input (receive) a natural language text through a communication network and to extract and output reputation information. It is noted that the reputation information extraction system 2000 is realized by the existing system described above.

For example, the reputation information extraction system includes a database for storing reputation information and extracts reputation information from the database on the basis of an input natural language text. Then, the reputation information extraction system 2000 outputs (transmits) the extracted reputation information to the reputation information service system 3000 through the communication network.

The reputation information service system 3000 is operated by, for example, a reputation information service operator and is specifically realized by an information processor such as a work station or a personal computer operated in accordance with a program.

The reputation information service system 3000 has a function to input (receive) a natural language text through a communication network from the service user terminal 5000 of a service user. Also, the reputation information service system 3000 has a function to make the reputation information extraction system 2000 output reputation information by using the input natural language text. For example, the reputation information service system 3000 outputs (transmits) the natural language text through the communication network to the reputation information extraction system 2000. Then, the reputation information service system 3000 inputs (receives) reputation information extracted by the reputation information extraction system 2000 through the communication network from the reputation information extraction system 2000.

Furthermore, the reputation information service system 3000 has a function to output (transmit) reputation information to the evaluation polarity estimation system 1000 for allowing the evaluation polarity estimation system 1000 to output a polarity degree (an evaluation polarity). Through this operation, the reputation information and the evaluation polarity are stored in the reputation information accumulation part included in the evaluation polarity estimation system 1000 (i.e., the reputation information storage part 202). Also, the reputation information service system 3000 has a function to transmit the reputation information and the polarity degree estimated by the evaluation polarity estimation system 1000 through the communication network to the service user terminal 5000 for providing them to a service user.

Furthermore, the reputation information service system 3000 has a function to output (transmit) reputation information and a polarity degree stored in the evaluation polarity estimation system 1000 through the communication network to the evaluation polarity reviewer terminal 4000 for providing them in response to a request issued from the evaluation polarity reviewer terminal 4000 of an evaluation polarity reviewer, so as to urge the evaluation polarity reviewer to correct the reputation information and the evaluation polarity. Also, the evaluation information service system 3000 has a function to record an amount of money for the reputation information service operator to receive from a service user (a service charge) and an amount of money to be paid to an evaluation polarity reviewer (a review charge).

In the following description, it is assumed that the evaluation information service system 3000 transmits/receives information to/from a terminal of a service user (namely, the service user terminal 5000) and a terminal of an evaluation polarity reviewer (namely, the evaluation polarity reviewer terminal 4000).

The service user terminal 5000 is a terminal operated by a service user and is specifically realized by an information processing terminal of a personal computer or the like. Although merely one service user terminal 5000 is illustrated in FIG. 17, the information service system may include a plurality of service user terminals 5000. Alternatively, the service user terminal 5000 may be a portable terminal such as a cellular phone or a PDA.

The evaluation polarity reviewer terminal 4000 is a terminal operated by an evaluation polarity reviewer and is specifically realized by an information processing terminal of a personal computer or the like. Although merely one evaluation polarity reviewer terminal 4000 is illustrated in FIG. 17, the information service system may include a plurality of evaluation polarity reviewer terminals 4000. Alternatively, the evaluation polarity reviewer terminal 4000 may be a portable terminal such as a cellular phone or a PDA.

Next, the structure of the reputation information service system 3000 will be described. As illustrated in FIG. 17, the reputation information service system 3000 includes a control unit and money information storing means 3002. The control unit 3001 is operated in accordance with a program stored in a storage device (not shown) included in the reputation information service system 3000. The control unit 3001 has a function to transmit/receive information to/from the service user terminal 5000, the evaluation polarity reviewer terminal 4000, the evaluation polarity estimation system 1000 and the reputation information extraction system 2000 through a communication network.

Although the reputation information service system 3000 includes a communication interface unit used for transmitting/receiving information in communication with the service user terminal 5000, the evaluation polarity reviewer terminal 400, the reputation information extraction system 2000 and the evaluation polarity estimation system 1000, the communication interface unit is omitted in FIG. 17. Accordingly, the control unit 3001 transmits/receives information to/from another component through the communication interface unit (not shown).

The money information storing means 3002 is specifically realized by a database device such as a magnetic disk unit or an optical disk unit. The money information storing means 30002 stores an amount of money to be paid by the reputation information service operator to an evaluation polarity reviewer (namely, a review charge) and an amount of money to be received from a service user (namely, a service charge). In this exemplary embodiment, the control unit 3001 has a function to calculate these amounts of money of the review charge and the service charge and to store them in the money information storing means 3002.

It is noted that the reputation information service operator is a service operator for providing the delivery service for reputation information and is an administrator of the reputation information service system 3000, the evaluation polarity estimation system and the reputation information extraction system 2000.

Also, in this exemplary embodiment, two of or all of the evaluation polarity estimation system 1000, the reputation information extraction system 2000 and the reputation information service system 3000 may be realized by using one information processor.

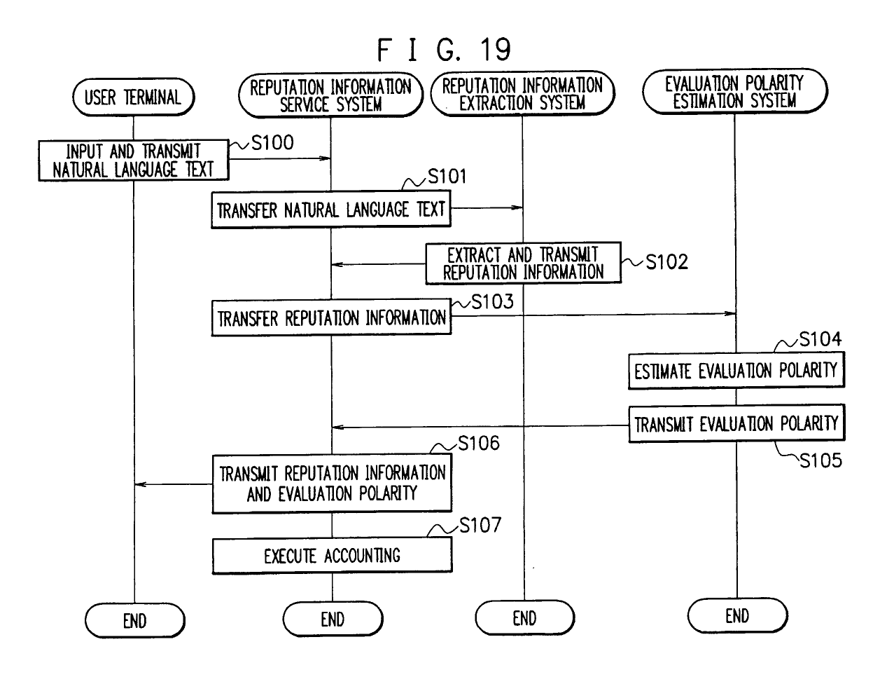

Next, operations will be described. First, an operation for delivering reputation information to the server user terminal 5000 will be described. FIG. 19 is a flowchart illustrating an exemplary process for delivering reputation information to the service user terminal 5000.

The service user terminal 5000 inputs, in accordance with an operation performed by a service user, a natural language text from which reputation information is to be extracted, and transmits it to the reputation information service system 3000 through a communication network (step S100). Then, the control unit 3001 of the reputation information service system 3000 receives information of the natural language text from the service user terminal 5000 through the communication network.

Next, the control unit 3001 acquires reputation information from the natural language text by using the reputation information extraction system 2000. Specifically, the control unit 3001 transfers (transmits) the natural language text received from the service user terminal 5000 to the reputation information extraction system 2000 through the communication network (step S101). Then, the reputation information extraction system 2000 extracts reputation information from a database on the basis of the received natural language text, and transmits the extracted information to the reputation information service system 3000 through the communication network (step S102).

Then, the control unit 3001 inputs an evaluative expression and obtains an evaluation polarity of the evaluative expression by using the evaluation polarity estimation system 2000. Specifically, the control unit 3001 transfers (transmits) the reputation information received from the evaluation polarity estimation system 1000 to the evaluation polarity estimation system 1000 through the communication network (step S103). The evaluation polarity estimation system 1000 inputs (receives) the reputation information and estimates the evaluation polarity through a process similar to the evaluation polarity estimation process described in Exemplary embodiment 1 (step S104), and returns the thus obtained estimation result to the reputation information service system 3000. Through this operation, the evaluation polarity estimation system 1000 transmits the estimated evaluation polarity to the reputation information service system 3000 through the communication network (step S105) and the reputation information and its evaluation polarity are stored in the reputation information accumulation part included in the evaluation polarity estimation system 1000 (i.e., the reputation information storage part 202).

Although the process similar to the evaluation polarity estimation process described in Exemplary embodiment 1 is executed by the evaluation polarity estimation system 1000 in this exemplary embodiment, the evaluation polarity estimation system may execute a process similar to the evaluation polarity estimation process described in Exemplary embodiment 2 or Exemplary embodiment 3.

The control unit 3001 transmits the reputation information extracted by the reputation information extraction system 2000 and the evaluation polarity of the reputation information estimated by the evaluation polarity estimation system 1000 to the service user terminal 5000 through the communication network (step S106). Then, the service user terminal 5000 presents the reputation information and the evaluation polarity to the service user. For example, the service user terminal 5000 displays the received reputation information and evaluation polarity on a display device such as a display.

Simultaneously, the control unit 3001 executes accounting for charging the service user with the use of the reputation information delivery service (step S107). Specifically, the control unit 3001 calculates an amount of money (a service charge) to be received from the service user and stores it in the money information storing means 3002. In this case, the control unit 3001 stores the money information and identification information of the service user correspondingly to each other in the money information storing means 3002.

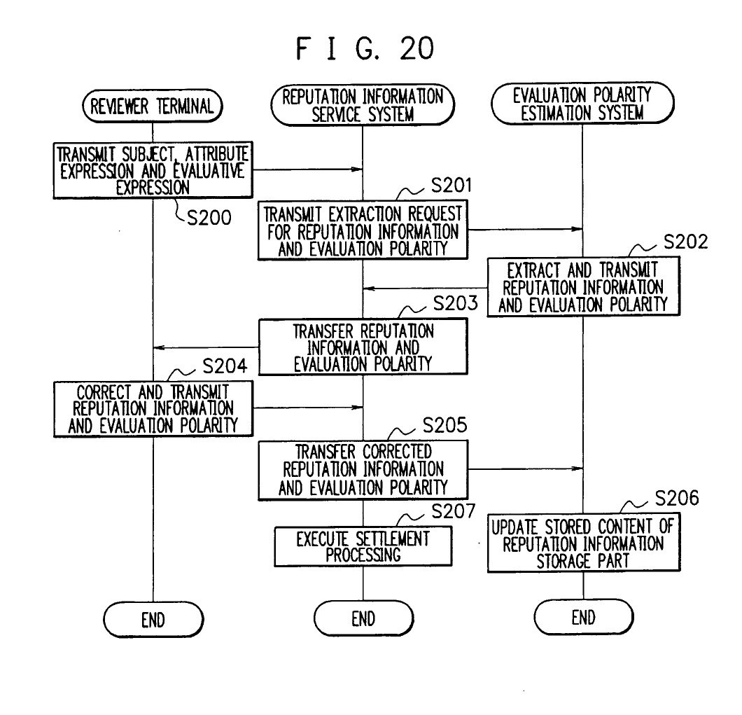

Next, an operation for reviewing reputation information and an evaluation polarity will be described. FIG. 20 is a flowchart illustrating an exemplary process for reviewing reputation information and an evaluation polarity.

In order to retrieve reputation information to be browsed or reviewed, the evaluation polarity reviewer terminal 4000 inputs a subject, an attribute expression and an evaluative expression in accordance with an operation performed by an evaluation polarity reviewer and transmits them to the reputation information service system 3000 through the communication network (step S200). Then, the control unit 3001 of the reputation information service system 3000 receives the subject, the attribute expression and the evaluative expression from the evaluation polarity reviewer terminal 4000 through the communication network.

When the subject, the attribute expression and the evaluative expression are received, the control unit 3001 reads reputation information and its evaluation polarity from the reputation information accumulation part (the reputation information storage part 202) by using the reputation information reading means 111 of the evaluation polarity estimation system 1000. Specifically, the control unit 3001 transmits an extraction request for reputation information and a corresponding evaluation polarity together with the received subject, attribute expression and evaluative expression to the evaluation polarity estimation system 1000 through the communication network (step S201). Then, the reputation information reading means 111 of the evaluation polarity estimation system 1000 extracts, from the reputation information storage part 202, reputation information corresponding to the received subject, attribute expression and evaluative expression and an evaluation polarity of the reputation information. Thereafter, the reputation information reading means 111 transmits the extracted reputation information and evaluation polarity to the reputation information service system through the communication network (step S202).

Subsequently, the control unit 3001 transmits (transfers) the reputation information and its evaluation polarity extracted by the evaluation polarity estimation system 1000 to the reviewer terminal 4000 through the communication network (step S203).

The reviewer terminal 400 receives the reputation information and its evaluation polarity through the communication network and presents them to the evaluation polarity reviewer for urging him/her to browse and review them. For example, the evaluation polarity reviewer terminal 4000 displays the received reputation information and evaluation polarity on a display device such as a display.

The evaluation polarity reviewer browses the reputation information and the evaluation polarity, and corrects the reputation information and the evaluation polarity if incorrect by operating the evaluation polarity reviewer terminal 4000. In this case, the evaluation polarity reviewer terminal 4000 corrects the reputation information and the evaluation polarity in accordance with an operation performed by the evaluation polarity reviewer and transmits the corrected content to the reputation information service system 3000 through the communication network (step S204).

Subsequently, the control unit 3001 of the reputation information service system 3000 transfers (transmits) the corrected reputation information and evaluation polarity thus received to the evaluation polarity estimation system 1000 through the communication network (step S205). Then, the reputation information writing means 112 of the evaluation polarity estimation system 1000 stores the corrected reputation information and evaluation polarity thus received in the reputation information storage part 202 for updating the stored contents of the reputation information storage part 202 (step S206).

Furthermore, the control unit 3001 executes settlement processing for payment of a review charge to the evaluation polarity reviewer for the review of the reputation information and the evaluation polarity (step S207). Specifically, the control unit 3001 calculates information of an amount of money to be paid by the reputation information service operator to the reviewer (namely, compensation for the review of the reputation (a review charge)) and stores the information in the money information storing means 3002. In this case, the control unit 3001 stores the money information and identification information of the evaluation polarity reviewer correspondingly to each other in the money information storing means 3001.

At this point, the service user may be identical to the evaluation polarity reviewer. In that case, there may be no need to pay compensation to the evaluation polarity reviewer (i.e., the service user), or the service charge to be paid by the service user may be reduced.

In this manner, according to the exemplary embodiment, the reputation information service system 3000 delivers reputation information extracted by the reputation information extraction system 2000 as well as an evaluation polarity estimated by the evaluation polarity estimation system 1000 in response to a request issued by the service user terminal 5000. In this case, when the number of correct polarity degrees stored in the evaluation polarity estimation system is increased by one (namely, every time one correct known polarity degree is stored), the accuracy of estimating an evaluation polarity of another related reputation information can be improved. Accordingly, the accuracy of estimating an evaluation polarity of reputation information can be improved with time while suppressing cost.

Also, in calculating an evaluation polarity of reputation information in the exemplary embodiment, the evaluation polarity is calculated on the basis of information stored in the reputation information accumulation part. Therefore, the estimation accuracy can be improved not only for reputation information reviewed by an evaluation polarity reviewer but also for another reputation information related to the reviewed reputation information.

Moreover, in order to improve the estimation accuracy for an evaluation polarity of reputation information in the conventional technique, every record of reputation information should be manually checked, and therefore, it is impossible to improve the estimation accuracy for an evaluation polarity in a short period of time after the start of the operation of the system. According to this exemplary embodiment, however, the estimation accuracy for an evaluation polarity can be improved in a shorter period of time after the start of the operation of the system than in the conventional technique.

### Exemplary Embodiment 5

Exemplary embodiment 5 of the invention will now be described with reference to the accompanying drawings. Although the polarity estimation system is described as an evaluation polarity estimation system in each of Exemplary embodiments 1 through 4, the polarity estimation system is applicable to estimation of a polarity other than an evaluation polarity of reputation information. For example, the polarity estimation system may be used for estimating a polarity of a set of keywords (hereinafter sometimes referred to as a keyword set) extracted from various documents such as contents of electric mails and information on the BBS. Furthermore, a polarity to be evaluated is not limited to one indicating information to be estimated is positive or negative but may be one used, when a keyword set to be estimated can be classified into one of some two concepts, for indicating which concept the keyword set falls under.

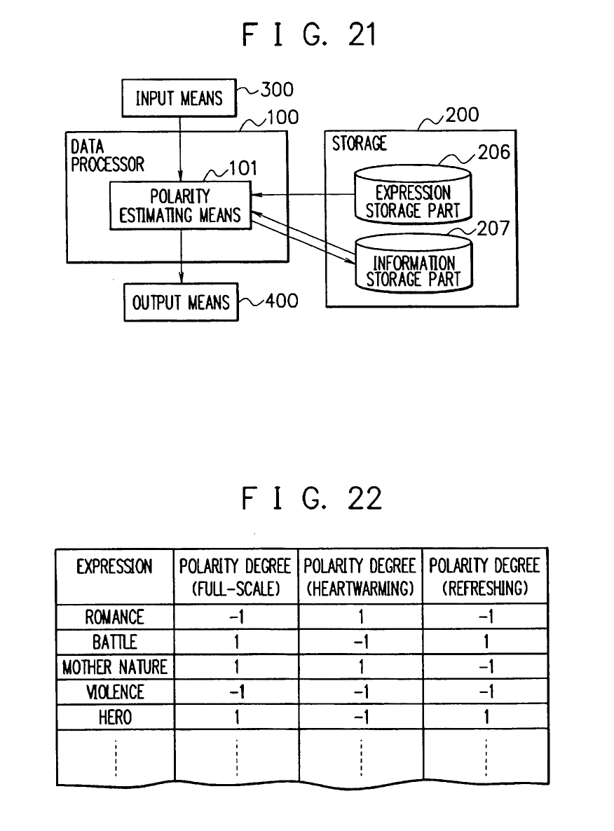

FIG. 21 is a block diagram illustrating an exemplary structure of a polarity estimation system according to Exemplary embodiment 5. As illustrated in FIG. 21, this exemplary embodiment is different from Exemplary embodiment 1 in a storage 200 including an expression storage part 206 and an information storage part 207 instead of the evaluative expression storage part 201 and the reputation information storage part 202. It is noted that the basic functions of the components other than the expression storage part 206 and the information storage part 207 are the same as those described in Exemplary embodiment 1.

In the following description, detailed description of similarity to the structure of Exemplary embodiment 1 will be omitted and differences from Exemplary embodiment 1 will be mainly described.

The expression storage part 206 precedently stores various expressions with known polarities. FIG. 22 is an explanatory diagram illustrating examples of the various expressions and polarities stored in the expression storage part 206. As illustrated in FIG. 22, the expression storage part 206 is a database storing an expression and various polarity degrees (polarities) correspondingly to each other. Also, in this exemplary embodiment, the expression storage part 206 stores a plurality of polarity degrees correspondingly to one expression as illustrated in FIG. 22.

One polarity used in this exemplary embodiment is information indicating whether or not the corresponding expression expresses a full-scale concept (which polarity is hereinafter sometimes referred to as the full-scale polarity). In the examples listed in FIG. 22, as a polarity degree of the full-scale polarity is closer to “1”, the corresponding expression expresses a more full-scale concept. On the other hand, as a polarity degree of the full-scale polarity is closer to “−1”, the corresponding expression is farther from a full-scale concept.

Furthermore, another polarity used in this exemplary embodiment is information indicating whether or not the corresponding expression expresses a heartwarming atmosphere (which polarity is hereinafter sometimes referred to as the heartwarming polarity). In the examples listed in FIG. 22, as a polarity degree of the heartwarming polarity is closer to “1”, the corresponding expression expresses a more heartwarming atmosphere. On the other hand, as a polarity degree of the heartwarming polarity is closer to “−1”, the corresponding expression expresses a more ice-cold atmosphere.

Furthermore, another polarity used in this exemplary embodiment is information indicating whether or not the corresponding expression expresses a refreshing atmosphere (which polarity is hereinafter sometimes referred to as the refreshing polarity). In the examples listed in FIG. 22, as a polarity degree of the refreshing polarity is closer to “1”, the corresponding expression expresses a more refreshing atmosphere. On the other hand, as a polarity degree of the refreshing polarity is closer to “−1”, the corresponding expression expresses a more depressing atmosphere.

For example, in the examples listed in FIG. 22, an expression “mother nature” is an expression with a full-scale concept and a heartwarming atmosphere, and hence, this expression has large values as the full-scale polarity and the heartwarming polarity. Also, since the expression “mother nature” is not an expression with a refreshing atmosphere, it has a small value as the refreshing polarity.

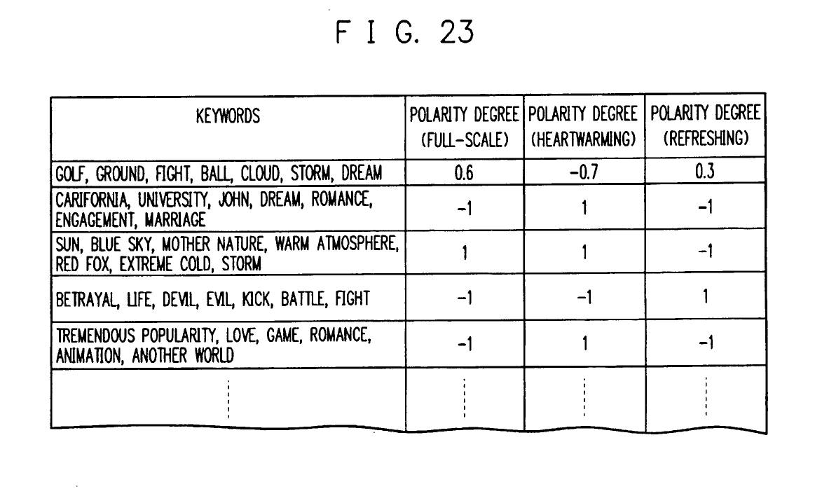

The information storage part 207 stores a keyword set and polarity degrees output by the polarity estimating means 101. FIG. 23 is an explanatory diagram illustrating examples of the keyword set and the polarity degrees stored in the information storage part 207. The information storage part 207 is a database storing a keyword set that can be included in each of various documents and respective polarity degrees of the keyword set correspondingly to each other. Also, in this exemplary embodiment, the information storage part 207 stores, as one record, a plurality of polarity degrees correspondingly to one keyword set. It is noted that the keyword set and the polarity degrees stored in the information storage part 207 are updated when necessary on the basis of polarity degrees output by the polarity estimating means 101.

Next, an operation will be described. In this exemplary embodiment, the polarity estimation system estimates various polarities of a keyword set in accordance with a process similar to the process for estimating an evaluation polarity of reputation information by the evaluation polarity estimation system described in Exemplary embodiment 1. First, the polarity estimating means 101 of the polarity estimation system inputs a keyword set to be estimated through the input means 300 in accordance with processing similar to that of step S10 described in Exemplary embodiment 1. Also, the polarity estimating means 101 calculates various polarity degrees of the keyword set to be estimated in accordance with processing similar to those of steps S11 through S14 described in Exemplary embodiment 1. Then, the polarity estimating means 101 makes the output means 400 output the calculated various polarity degrees in accordance with processing similar to that of step S16 described in Exemplary embodiment 1.

For example, when the keyword set includes a keyword according with any expression stored in the expression storage part 206, the polarity estimating means 101 extracts respective polarity degrees of the expression from the expression storage part 206 in accordance with the processing similar to that of step S11. Alternatively, when the expression storage part 206 does not store any according expression, the polarity estimating means 101 obtains an individual polarity degree by, for example, obtaining an average value of polarity degrees of records including expressions according with any of keywords of the keyword set out of the records stored in the information storage part 207 in accordance with the processing similar to that of step S13. For example, in the examples listed in FIG. 23, when a polarity degree of the full-scale polarity is to be calculated, all records including keywords “golf”, “ground”, “fight”, “ball”, “cloud”, “storm” and “dream” are extracted from the records stored in the information storage part 207, and an average value of the polarity degrees included in the extracted records is obtained.

In this manner, according to the exemplary embodiment, a polarity degree is calculated with respect to each keyword included in information with known polarities. Also, a polarity degree is output by comparing for a keyword included in information with an unknown polarity. Therefore, with respect to information with an unknown polarity, various polarities can be estimated by utilizing information with a known polarity.

Although it is described in this exemplary embodiment that various polarities of a keyword set are estimated in accordance with the process similar to the process for estimating an evaluation polarity described in Exemplary embodiment 1, various polarities of a keyword set may be estimated in accordance with a process similar to that of Exemplary embodiment 2 or Exemplary embodiment 3. For example, the polarity estimation system may estimate various polarities of a keyword set by performing prescribed weighting processing in addition to the processing described in this exemplary embodiment. Alternatively, the polarity estimation system may estimate various polarities of a keyword set in consideration of a type of a person having determined the polarity of each keyword in addition to the processing described in this exemplary embodiment. Furthermore, the polarity estimation system may be applied to a service model for delivering a polarity together with a keyword set in accordance with, for example, a process similar to that of Exemplary embodiment 4.

The present invention has been described by making reference to the exemplary embodiments so far, and the invention is not limited to the exemplary embodiments described above. It will be obvious to those skilled in the art that various changes and modifications may be made in the structures and the details of the invention without departing from the scope of the invention.

For example, in another exemplary aspect of the polarity estimation system according to this invention, an evaluative expression storage part that precedently stores an evaluative expression corresponding to an expression of evaluation of a subject (which is realized by, for example, the evaluative expression storage part 201) may be included, and the evaluative expression storage part may store, correspondingly to each evaluative expression, an evaluative expression polarity indicating whether the corresponding evaluative expression includes a positive expression or a negative expression, and the polarity estimating means may estimate the evaluation polarity of the reputation information with the unknown evaluation polarity on the basis of the evaluative expression and the evaluative expression polarity stored in the evaluative expression storage part.

For example, in another exemplary aspect of the polarity estimation system according to this invention, the reputation information storage part may store reputation information and an evaluation polarity of the reputation information correspondingly to each other, and the polarity estimating means may estimate the evaluation polarity of the reputation information with the unknown evaluation polarity on the basis of the reputation information and the evaluation polarity stored in the reputation information storage p art.

For example, in another exemplary aspect of the polarity estimation system according to this invention, the reputation information storage part may store, correspondingly to reputation information, acquirement time information indicating time when the reputation information was acquired (such as the time illustrated in FIG. 8 when the reputation information was acquired), the polarity estimating means may include weighting means (which is realized by, for example, the weighting means 1021) performing prescribed weighting processing on the evaluation polarity of the reputation information stored in the reputation information storage part, and the polarity estimating means may estimate the evaluation polarity of the reputation information with the unknown polarity on the basis of an evaluation polarity resulting from the weighting processing performed by the weighting means and the reputation information stored in the reputation information storage part.

For example, in another exemplary aspect of the polarity estimation system according to this invention, the reputation information storage part may store, correspondingly to reputation information, evaluator information (such as an evaluator ID) indicating an evaluator having evaluated the reputation information, and the polarity estimating means may estimate the evaluation polarity of the reputation information with the unknown polarity on the basis of the reputation information and the evaluator information stored in the reputation information storage part.

For example, in another exemplary aspect of the polarity estimation system according to this invention, the polarity estimating means may calculate a polarity degree of an attribute expression included in reputation information with a known evaluation polarity, a polarity degree of a subject included in the reputation information and a polarity degree of an evaluative expression included in the reputation information, and may calculate a comprehensive polarity degree by comprehensively integrating polarity degrees calculated based on the input reputation information on the basis of one of or a set of two or more of the calculated polarity degrees.

For example, in another exemplary aspect of the polarity estimation system according to this invention, the polarity estimating means may obtain a comprehensive polarity degree by calculating one of or an average, a sum or a ratio of two or more of a polarity degree of an attribute expression, a polarity degree of a subject and a polarity degree of an evaluative expression.

For example, in another exemplary aspect of the polarity estimation system according to this invention, the polarity estimating means may obtain the polarity degree of the attribute expression by obtaining a sum of polarity degrees of reputation information, out of the reputation information stored in the reputation information storage part, including an attribute expression included in the input reputation information, by obtaining an average of the polarity degrees of the reputation information including the attribute expression included in the input reputation information or by calculating a ratio of the reputation information including the attribute expression included in the input reputation information.

For example, in another exemplary aspect of the polarity estimation system according to this invention, the polarity estimating means may obtain the polarity degree of the subject by obtaining a sum of polarity degrees of reputation information, out of the reputation information stored in the reputation information storage part, including a subject included in the input reputation information, by obtaining an average of the polarity degrees of the reputation information including the subject included in the input reputation information or by calculating a ratio of the reputation information including the subject included in the input reputation information.

For example, in another exemplary aspect of the polarity estimation system according to this invention, the polarity estimating means may obtain the polarity degree of the evaluative expression by obtaining a sum of polarity degrees of reputation information, out of the reputation information stored in the reputation information storage part, including an evaluative expression included in the input reputation information, by obtaining an average of the polarity degrees of the reputation information including the evaluative expression included in the input reputation information or by calculating a ratio of the reputation information including the evaluative expression included in the input reputation information.

For example, in another exemplary aspect of the polarity estimation system according to this invention, the polarity estimating means may calculate a polarity degree with a weight given in the order of time when reputation information was acquired.

For example, in another exemplary aspect of the polarity estimation system according to this invention, the polarity estimating means may calculate a polarity degree with respect to each evaluator type corresponding to a type of an evaluator having evaluated the reputation information.

For example, in another exemplary aspect of the polarity estimation system according to this invention, the polarity estimating means may calculate a polarity degree with respect to each of an age, a sex, an occupation, an interest or a purchased product as an evaluator type for the reputation information.

For example, in another exemplary aspect of the polarity estimation system according to this invention, the polarity estimating means may obtain a comprehensive polarity degree by calculating one of or an average, a sum or a ratio of two or more of polarity degrees of respective keywords included in information stored in the information storage part.

For example, in another exemplary aspect of the polarity estimation system according to this invention, the polarity estimating means may calculate a polarity degree with a weight given in the order of time when the information stored in the information storage part was acquired.

For example, in another exemplary aspect of the polarity estimation system according to this invention, the polarity estimating means may calculate a polarity degree with respect to each evaluator type corresponding to a type of an evaluator having evaluated the information stored in the information storage part.

For example, in another exemplary aspect of the polarity estimation system according to this invention, the polarity estimating means may calculate a polarity degree with respect to each of an age, a sex, an occupation, an interest and a purchased product of an evaluator as an evaluator type for the information stored in the information storage part.

For example, in another exemplary aspect of the polarity estimation method according to this invention, an evaluative expression storing step of precedently storing an evaluative expression corresponding to an expression of evaluation of a subject may be included, an evaluative expression polarity indicating whether the evaluative expression includes a positive expression or a negative expression may be stored corresponding to the evaluative expression in the evaluative expression storing step, and the evaluation polarity of the reputation information with the unknown evaluation polarity may be estimated in the polarity estimating step on the basis of the stored evaluative expression and evaluative expression polarity.

For example, in another exemplary aspect of the polarity estimation method according to this invention, reputation information and an evaluation polarity of the reputation information may be stored correspondingly to each other in the reputation information storing step, the evaluation polarity of the reputation information with the unknown evaluation polarity may be estimated in the polarity estimating step on the basis of the stored reputation information and evaluation polarity.

For example, in another exemplary aspect of the polarity estimation method according to this invention, acquirement time information indicating time when the reputation information was acquired may be stored correspondingly to the reputation information in the reputation information storing step, prescribed weighting processing may be performed in the polarity estimating step on the evaluation polarity of the stored reputation information on the basis of the stored acquirement time information, the evaluation polarity of the reputation information with the unknown polarity may be estimated in the polarity estimating step on the basis of an evaluation polarity resulting from the weighting processing and the stored reputation information.

For example, in another exemplary aspect of the polarity estimation method according to this invention, evaluator information indicating an evaluator having evaluated the reputation information may be stored correspondingly to the reputation information in a reputation information storing step, the evaluation polarity of the reputation information with the unknown polarity may be estimated in the polarity estimating step on the basis of the stored reputation information and evaluator information.

For example, in another exemplary aspect of the polarity estimation method according to this invention, a polarity degree of an attribute expression included in the reputation information with the known evaluation polarity, a polarity degree of a subject included in the reputation information and a polarity degree of an evaluative expression included in the reputation information may be calculated in the polarity estimating step, and a comprehensive polarity degree may be calculated by comprehensively integrating polarity degrees calculated based on the input reputation information on the basis of one of or a set of two or more of the calculated polarity degrees.

For example, in another exemplary aspect of the polarity estimation method according to this invention, a comprehensive polarity degree may be obtained in the polarity estimating step by calculating one of or an average, a sum or a ratio of two or more of a polarity degree of an attribute expression, a polarity degree of a subject and a polarity degree of an evaluative expression.

For example, in another exemplary aspect of the polarity estimation method according to this invention, the polarity degree of the attribute expression may be obtained in the polarity estimating step by obtaining a sum of polarity degrees of reputation information, out of the stored reputation information, including an attribute expression included in the input reputation information, by obtaining an average of the polarity degrees of the reputation information including the attribute expression included in the input reputation information or by calculating a ratio of the reputation information including the attribute expression included in the input reputation information.

For example, in another exemplary aspect of the polarity estimation method according to this invention, the polarity degree of the subject may be obtained in the polarity estimating step by obtaining a sum of polarity degrees of reputation information, out of the stored reputation information, including a subject included in the input reputation information, by obtaining an average of the polarity degrees of the reputation information including the subject included in the input reputation information or by calculating a ratio of the reputation information including the subject included in the input reputation information.

For example, in another exemplary aspect of the polarity estimation method according to this invention, the polarity degree of the evaluative expression may be obtained in the polarity estimating step by obtaining a sum of polarity degrees of reputation information, out of the stored reputation information, including an evaluative expression included in the input reputation information, by obtaining an average of the polarity degrees of the reputation information including the evaluative expression included in the input reputation information or by calculating a ratio of the reputation information including the evaluative expression included in the input reputation information.

For example, in another exemplary aspect of the polarity estimation method according to this invention, a polarity degree may be calculated in the polarity estimating step with a weight given in the order of time when the reputation information was acquired.

For example, in another exemplary aspect of the polarity estimation method according to this invention, a polarity degree may be calculated in the polarity estimating step with respect to each evaluator type corresponding to a type of an evaluator having evaluated the reputation information.

For example, in another exemplary aspect of the polarity estimation method according to this invention, a polarity degree may be calculated in the polarity estimating step with respect to each of an age, a sex, an occupation, an interest or a purchased product as an evaluator type for the reputation information.

For example, in another exemplary aspect of the polarity estimation program according to this invention, the computer may be caused to execute evaluative expression storing processing for precedently storing an evaluative expression corresponding to an expression of evaluation of a subject, the computer may be caused to execute processing for storing, correspondingly to each evaluative expression, an evaluative expression polarity indicating whether the corresponding evaluative expression includes a positive expression or a negative expression in the evaluative expression storing processing, and the computer may be caused to execute, in the polarity estimating step, processing for estimating the evaluation polarity of the reputation information with the unknown evaluation polarity on the basis of the stored evaluative expression and evaluative expression polarity.

For example, in another exemplary aspect of the polarity estimation program according to this invention, the computer may be caused to execute, in the reputation information storing processing, processing for storing reputation information and an evaluation polarity of the reputation information correspondingly to each other, and caused to execute, in the polarity evaluation polarity, processing for estimating the evaluation polarity of the reputation information with the unknown evaluation polarity on the basis of the stored reputation information and evaluation polarity.

For example, in another exemplary aspect of the polarity estimation program according to this invention, the computer may be caused to execute, in the reputation information storing processing, processing for storing, correspondingly to each reputation information, acquirement time information indicating time when the reputation information was acquired, and caused to execute prescribed weighting processing on the evaluation polarity of the stored reputation information on the basis of the stored acquirement time information, and caused to execute processing for estimating the evaluation polarity of the reputation information with the unknown polarity on the basis of an evaluation polarity resulting from the weighting processing and the stored reputation information.

For example, in another exemplary aspect of the polarity estimation program according to this invention, the computer may be caused to execute, in the reputation information storing processing, processing for storing, correspondingly to each reputation information, evaluator information indicating an evaluator having evaluated the reputation information, and caused to execute, in the polarity evaluation polarity, processing for estimating the evaluation polarity of the reputation information with the unknown polarity on the basis of the stored reputation information and evaluator information.

For example, in another exemplary aspect of the polarity estimation program according to this invention, the computer may be caused to execute, in the polarity evaluation polarity, processing for calculating a polarity degree of an attribute expression included in reputation information with a known evaluation polarity, a polarity degree of a subject included in the reputation information and a polarity degree of an evaluative expression included in the reputation information, and caused to execute processing for calculating a comprehensive polarity degree by comprehensively integrating polarity degrees calculated with respect to the input reputation information on the basis of one of or a set of two or more of the calculated polarity degrees.

For example, in another exemplary aspect of the polarity estimation program according to this invention, the computer may be caused to execute, in the polarity evaluation polarity, processing for obtaining a comprehensive polarity degree by calculating one of or an average, a sum or a ratio of two or more of a polarity degree of an attribute expression, a polarity degree of a subject and a polarity degree of an evaluative expression.

For example, in another exemplary aspect of the polarity estimation program according to this invention, the computer may be caused to execute, in the polarity evaluation polarity, processing for obtaining the polarity degree of the attribute expression by obtaining a sum of polarity degrees of reputation information, out of the stored reputation information, including an attribute expression included in the input reputation information, by obtaining an average of the polarity degrees of the reputation information including the attribute expression included in the input reputation information or by calculating a ratio of the reputation information including the attribute expression included in the input reputation information.

For example, in another exemplary aspect of the polarity estimation program according to this invention, the computer may be caused to execute, in the polarity evaluation polarity, processing for obtaining the polarity degree of the subject by obtaining a sum of polarity degrees of reputation information, out of the stored reputation information, including a subject included in the input reputation information, by obtaining an average of the polarity degrees of the reputation information including the subject included in the input reputation information or by calculating a ratio of the reputation information including the subject included in the input reputation information.

For example, in another exemplary aspect of the polarity estimation program according to this invention, the computer may be caused to execute, in the polarity evaluation polarity, processing for obtaining the polarity degree of the evaluative expression by obtaining a sum of polarity degrees of reputation information, out of the stored reputation information, including an evaluative expression included in the input reputation information, by obtaining an average of the polarity degrees of the reputation information including the evaluative expression included in the input reputation information or by calculating a ratio of the reputation information including the evaluative expression included in the input reputation information.

For example, in another exemplary aspect of the polarity estimation program according to this invention, the computer may be caused to execute, in the polarity evaluation polarity, processing for calculating a polarity degree with a weight given in the order of time when the reputation information was acquired.

For example, in another exemplary aspect of the polarity estimation program according to this invention, the computer may be caused to execute, in the polarity evaluation polarity, processing for calculating a polarity degree with respect to each evaluator type corresponding to a type of an evaluator having evaluated the reputation information.

For example, in another exemplary aspect of the polarity estimation program according to this invention, the computer may be caused to execute, in the polarity evaluation polarity, processing for calculating a polarity degree with respect to each of an age, a sex, an occupation, an interest or a purchased product as an evaluator type for the reputation information.

The present invention is applicable to service, for example, for grasping outlines of a product, such as a good feature and a bad feature, by determining an evaluation polarity of reputation information. Also, the present invention is applicable to an automatic survey collating system.

1-52. (canceled)

53. A polarity estimation system for estimating an evaluation polarity indicating whether reputation information is positive or negative, comprising:
an evaluative expression storage part that stores an evaluative expression corresponding to an expression of evaluation of a subject and an evaluative expression polarity indicating whether the evaluative expression includes a positive expression or a negative expression correspondingly to each other;
a reputation information storage part that stores reputation information and an evaluation polarity of the reputation information correspondingly to each other; and
a polarity estimating unit that estimates an evaluation polarity of reputation information with an unknown evaluation polarity on the basis of the evaluative expression and the evaluative expression polarity stored in the evaluative expression storage part and estimates the evaluation polarity of the reputation information with the unknown evaluation polarity on the basis of the reputation information and the evaluation polarity stored in the reputation information storage part,
wherein the reputation information storage part stores, correspondingly to the reputation information, acquirement time information indicating time when the reputation information was acquired,
the polarity estimating unit includes a weighting unit that performs prescribed weighting processing on the evaluation polarity corresponding to the reputation information stored in the reputation information storage part on the basis of the acquirement time information stored in the reputation information storage part, and
the weighting unit estimates the evaluation polarity of the reputation information with the unknown evaluation polarity on the basis of an evaluation polarity resulting from the weighting processing and the reputation information stored in the reputation information storage part.

54. The polarity estimation system according to claim 53,
wherein the reputation information storage part stores, correspondingly to the reputation information, evaluator information indicating an evaluator having evaluated the reputation information, and
the polarity estimating unit estimates the evaluation polarity of the reputation information with the unknown evaluation polarity on the basis of the reputation information and the evaluator information stored in the reputation information storage part.

55. A polarity estimation system, in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, comprising:
an evaluative expression storage part that stores an evaluation polarity corresponding to an evaluative expression;
a reputation information storage part that stores reputation information and an evaluation polarity corresponding to the reputation information; and
a polarity estimating unit that estimates the evaluation polarity of the input reputation information on the basis of the evaluation polarity stored in the evaluative expression storage part and the reputation information with the known evaluation polarity stored in the reputation information storage part and calculates, as the evaluation polarity, a polarity degree corresponding to a positive degree or a negative degree of the reputation information,
wherein the polarity estimating unit calculates a polarity degree corresponding to an attribute expression included in the reputation information with the known evaluation polarity, a polarity degree corresponding to a subject included in the reputation information and a polarity degree corresponding to an evaluative expression included in the reputation information, and
the polarity estimating unit calculates a comprehensive polarity degree obtained by comprehensively integrating a polarity degree corresponding to the attribute expression, a polarity degree corresponding to the subject and a polarity degree corresponding to the evaluative expression calculated with respect to the input reputation information on the basis of one of the calculated polarity degrees or a set of two or more of the calculated polarity degrees calculated with respect to the reputation information with the known evaluation polarity.

56. The polarity estimation system according to claim 55,
wherein the polarity estimating unit obtains the comprehensive polarity degree by calculating one of or an average, a sum or a ratio of two or more of the polarity degree corresponding to the attribute expression, the polarity degree corresponding to the subject and the polarity degree corresponding to the evaluative expression.

57. The polarity estimation system according to claim 55,
wherein the polarity estimating unit obtains the polarity degree corresponding to the attribute expression by obtaining a sum of polarity degrees corresponding to reputation information, out of the reputation information stored in the reputation information storage part, including the attribute expression included in the input reputation information, by obtaining an average of the polarity degrees corresponding to the reputation information including the attribute expression included in the input reputation information or by calculating a ratio of the reputation information including the attribute expression included in the input reputation information.

58. The polarity estimation system according to claim 55,
wherein the polarity estimating unit obtains the polarity degree corresponding to the subject by obtaining a sum of polarity degrees corresponding to reputation information, out of the reputation information stored in the reputation information storage part, including the subject included in the input reputation information, by obtaining an average of the polarity degrees corresponding to the reputation information including the subject included in the input reputation information or by calculating a ratio of the reputation information including the subject included in the input reputation information.

59. The polarity estimation system according to claim 55,
wherein the polarity estimating unit obtains the polarity degree corresponding to the evaluative expression by obtaining a sum of polarity degrees corresponding to reputation information, out of the reputation information stored in the reputation information storage part, including the evaluative expression included in the input reputation information, by obtaining an average of the polarity degrees corresponding to the reputation information including the evaluative expression included in the input reputation information or by calculating a ratio of the reputation information including the evaluative expression included in the input reputation information.

60. The polarity estimation system according to claim 55,
wherein the polarity estimating unit calculates the polarity degree with a weight given in the order of time when the reputation information was acquired.

61. The polarity estimation system according to claim 55,
wherein the polarity estimating unit calculates the polarity degree with respect to an evaluator type corresponding to a type of an evaluator having evaluated the reputation information.

62. The polarity estimation system according to claim 55,
wherein the polarity estimating unit calculates the polarity degree with respect to each of an age, a sex, an occupation, an interest and a purchased product of an evaluator as an evaluator type for the reputation information.

63. An information delivery system comprising:
a reputation information delivery system that delivers reputation information; and
an evaluation polarity estimation system that estimates an evaluation polarity indicating whether reputation information is positive or negative,
wherein the evaluation polarity estimation system includes:
an evaluative expression storage part that stores an evaluation polarity corresponding to an evaluative expression;
a reputation information storage part that stores reputation information and an evaluation polarity corresponding to the reputation information; and
a polarity estimating unit that calculates a polarity degree corresponding to an attribute expression included in reputation information with a known evaluation polarity, a polarity degree corresponding to a subject included in the reputation information and a polarity degree corresponding to an evaluative expression included in the reputation information, calculates a comprehensive polarity degree obtained by comprehensively integrating a polarity degree corresponding to an attribute expression, a polarity degree corresponding to a subject and a polarity degree corresponding to an evaluative expression calculated with respect to input reputation information on the basis of one of the calculated polarity degrees or a set of two or more of the calculated polarity degrees calculated with respect to the reputation information with the known evaluation polarity, and calculates, as the evaluation polarity, a polarity degree corresponding to a positive degree or a negative degree of the reputation information, and
the reputation information delivery system includes an information delivering unit that transmits not only the reputation information but also the evaluation polarity estimated by the evaluation polarity estimation system to a user terminal through a communication network.

64. A polarity estimation method for estimating an evaluation polarity indicating whether reputation information is positive or negative, comprising:
an evaluative expression storing step of storing an evaluative expression corresponding to an expression of evaluation of a subject and an evaluative expression polarity indicating whether the evaluative expression includes a positive expression or a negative expression correspondingly to each other;
a reputation information storing step of storing reputation information and an evaluation polarity of the reputation information correspondingly to each other; and
a polarity estimating step of estimating an evaluation polarity of reputation information with an unknown evaluation polarity on the basis of the evaluative expression and the evaluative expression polarity stored in the evaluative expression storing step and estimating the evaluation polarity of the reputation information with the unknown evaluation polarity on the basis of the reputation information and the evaluation polarity stored in the reputation information storing step,
wherein acquirement time information indicating time when the reputation information was acquired is stored correspondingly to the reputation information in the reputation information storing step,
prescribed weighting processing is performed on the evaluation polarity corresponding to the stored reputation information on the basis of the stored acquirement time information in the polarity estimating step, and
the evaluation polarity of the reputation information with the unknown evaluation polarity is estimated in the polarity estimating step on the basis of an evaluation polarity resulting from the weighting processing and the stored reputation information.

65. The polarity estimation method according to claim 64,
wherein evaluator information indicating an evaluator having evaluated the reputation information is stored correspondingly to the reputation information in the reputation information storing step, and
the evaluation polarity of the reputation information with the unknown evaluation polarity is estimated in the polarity estimating step on the basis of the stored reputation information and evaluator information.

66. A polarity estimation method in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, comprising:
an evaluative expression storing step of storing an evaluation polarity corresponding to an evaluative expression;
a reputation information storing step of storing reputation information and an evaluation polarity corresponding to the reputation information; and
a polarity estimating step of estimating the evaluation polarity of the input reputation information on the basis of the evaluation polarity stored in the evaluative expression storing step and the reputation information with the known evaluation polarity stored in the reputation information storing step and calculating, as the evaluation polarity, a polarity degree corresponding to a positive degree or a negative degree of the reputation information,
wherein a polarity degree corresponding to an attribute expression included in the reputation information with the known evaluation polarity, a polarity degree corresponding to a subject included in the reputation information and a polarity degree corresponding to an evaluative expression included in the reputation information are calculated in the polarity estimating step, and
a comprehensive polarity degree is calculated in the polarity estimating step by comprehensively integrating a polarity degree corresponding to the attribute expression, a polarity degree corresponding to the subject and a polarity degree corresponding to the evaluative expression calculated with respect to the input reputation information on the basis of one of the calculated polarity degrees or a set of two or more of the calculated polarity degrees calculated with respect to the reputation information with the known evaluation polarity.

67. The polarity estimation method according to claim 66,
wherein the comprehensive polarity degree is obtained in the polarity estimating step by calculating one of or an average, a sum or a ratio of two or more of the polarity degree corresponding to the attribute expression, the polarity degree corresponding to the subject and the polarity degree corresponding to the evaluative expression.

68. The polarity estimation method according to claim 66,
wherein the polarity degree corresponding to the attribute expression is obtained in the polarity estimating step by obtaining a sum of polarity degrees corresponding to reputation information, out of the stored reputation information, including the attribute expression included in the input reputation information, by obtaining an average of the polarity degrees corresponding to the reputation information including the attribute expression included in the input reputation information or by calculating a ratio of the reputation information including the attribute expression included in the input reputation information.

69. The polarity estimation method according to claim 66,
wherein the polarity degree corresponding to the subject is obtained in the polarity estimating step by obtaining a sum of polarity degrees corresponding to reputation information, out of the stored reputation information, including the subject included in the input reputation information, by obtaining an average of the polarity degrees corresponding to the reputation information including the subject included in the input reputation information or by calculating a ratio of the reputation information including the subject included in the input reputation information.

70. The polarity estimation method according to claim 66,
wherein the polarity degree corresponding to the evaluative expression is obtained in the polarity estimating step by obtaining a sum of polarity degrees corresponding to reputation information, out of the stored reputation information, including the evaluative expression included in the input reputation information, by obtaining an average of the polarity degrees corresponding to the reputation information including the evaluative expression included in the input reputation information or by calculating a ratio of the reputation information including the evaluative expression included in the input reputation information.

71. The polarity estimation method according to claim 66,
wherein the polarity degree is calculated in the polarity estimating step with a weight given in the order of time when the reputation information was acquired.

72. The polarity estimation method according to claim 66,
wherein the polarity degree is calculated in the polarity estimating step with respect to an evaluator type corresponding to a type of an evaluator having evaluated the reputation information.

73. The polarity estimation method according to claim 66,
wherein the polarity degree is calculated in the polarity estimating step with respect to each of an age, a sex, an occupation, an interest and a purchased product of an evaluator as an evaluator type for the reputation information.

74. A storage medium for storing a polarity estimation program, used for estimating an evaluation polarity indicating whether reputation information is positive or negative, that causes a computer to execute:
evaluative expression storing processing for storing an evaluative expression corresponding to an expression of evaluation of a subject and an evaluative expression polarity indicating whether the evaluative expression includes a positive expression or a negative expression correspondingly to each other;
reputation information storing processing for storing reputation information and an evaluation polarity of the reputation information correspondingly to each other; and
polarity estimating processing for estimating an evaluation polarity of reputation information with an unknown evaluation polarity on the basis of the stored evaluative expression and evaluative expression polarity and estimating the evaluation polarity of the reputation information with the unknown evaluation polarity on the basis of the stored reputation information and evaluation polarity,
wherein the computer is caused to execute, in the reputation information storing processing, processing for storing, correspondingly to the reputation information, acquirement time information indicating time when the reputation information was acquired,
the computer is caused to execute, in the polarity estimating processing, prescribed weighting processing on the evaluation polarity corresponding to the stored reputation information on the basis of the stored acquirement time information, and
the computer is caused to execute, in the polarity estimating processing, processing for estimating the evaluation polarity of the reputation information with the unknown evaluation polarity on the basis of an evaluation polarity resulting from the weighting processing and the stored reputation information.

75. The storage medium for storing the polarity estimation program according to claim 74,
wherein the computer is caused to execute, in the reputation information storing processing, processing for storing, correspondingly to the reputation information, evaluator information indicating an evaluator having evaluated the reputation information, and
the computer is caused to execute, in the polarity estimating processing, processing for estimating the evaluation polarity of the reputation information with the unknown evaluation polarity on the basis of the stored reputation information and evaluator information.

76. A storage medium for storing a polarity estimation program, in which reputation information including a subject to be evaluated, an attribute expression corresponding to an attribute of the subject and an evaluative expression corresponding to an expression of evaluation of the subject is input for estimating an evaluation polarity indicating whether the input reputation information is positive or negative, that causes a computer to execute:
evaluative expression storing processing for storing an evaluation polarity corresponding to an evaluative expression;
reputation information storing processing for storing reputation information and an evaluation polarity corresponding to the reputation information; and
polarity estimating processing for estimating the evaluation polarity of the input reputation information on the basis of the evaluation polarity stored in the evaluative expression storing processing and the reputation information with the known evaluation polarity stored in the reputation information storing processing and calculating, as the evaluation polarity, a polarity degree corresponding to a positive degree or a negative degree of the reputation information,
wherein the computer is caused to execute, in the polarity estimating processing, processing for calculating a polarity degree corresponding to an attribute expression included in the reputation information with the known evaluation polarity, a polarity degree corresponding to a subject included in the reputation information and a polarity degree corresponding to an evaluative expression included in the reputation information, and
the computer is caused to execute, in the polarity estimating processing, processing for calculating a comprehensive polarity degree obtained by comprehensively integrating a polarity degree corresponding to the attribute expression, a polarity degree corresponding to the subject and a polarity degree corresponding to the evaluative expression calculated with respect to the input reputation information on the basis of one of the calculated polarity degrees or a set of two or more of the calculated polarity degrees calculated with respect to the reputation information with the known evaluation polarity.

77. The storage medium for storing the polarity estimation program according to claim 76,
wherein the computer is caused to execute, in the polarity estimating processing, processing for obtaining the comprehensive polarity degree by calculating one of or an average, a sum or a ratio of two or more of the polarity degree corresponding to the attribute expression, the polarity degree corresponding to the subject and the polarity degree corresponding to the evaluative expression.

78. The storage medium for storing the polarity estimation program according to claim 76,
wherein the computer is caused to execute, in the polarity estimating processing, processing for obtaining the polarity degree corresponding to the attribute expression by obtaining a sum of polarity degrees corresponding to reputation information, out of the reputation information stored in the reputation information storage part, including the attribute expression included in the input reputation information, by obtaining an average of the polarity degrees corresponding to the reputation information including the attribute expression included in the input reputation information or by calculating a ratio of the reputation information including the attribute expression included in the input reputation information.

79. The storage medium for storing the polarity estimation program according to claim 76,
wherein the computer is caused to execute, in the polarity estimating processing, processing of obtaining the polarity degree corresponding to the subject by obtaining a sum of polarity degrees corresponding to reputation information, out of the reputation information stored in the reputation information storage part, including the subject included in the input reputation information, by obtaining an average of the polarity degrees corresponding to the reputation information including the subject included in the input reputation information or by calculating a ratio of the reputation information including the subject included in the input reputation information.

80. The storage medium for storing the polarity estimation program according to claim 76,
wherein the computer is caused to execute, in the polarity estimating processing, processing for obtaining the polarity degree corresponding to the evaluative expression by obtaining a sum of polarity degrees corresponding to reputation information, out of the reputation information stored in the reputation information storage part, including the evaluative expression included in the input reputation information, by obtaining an average of the polarity degrees corresponding to the reputation information including the evaluative expression included in the input reputation information or by calculating a ratio of the reputation information including the evaluative expression included in the input reputation information.

81. The storage medium for storing the polarity estimation program according to claim 76,
wherein the computer is caused to execute, in the polarity estimating processing, processing for calculating the polarity degree with a weight given in the order of time when the reputation information was acquired.

82. The storage medium for storing the polarity estimation program according to claim 76,
wherein the computer is caused to execute, in the polarity estimating processing, processing for calculating the polarity degree with respect to an evaluator type corresponding to a type of an evaluator having evaluated the reputation information.

83. The storage medium for storing the polarity estimation program according to claim 76,
wherein the computer is caused to execute, in the polarity estimating processing, processing for calculating the polarity degree with respect to each of an age, a sex, an occupation, an interest and a purchased product of an evaluator as an evaluator type for the reputation information.

84. A storage medium for storing an evaluation polarity estimation program to be provided onboard in a computer, in which reputation information including a subject to be evaluated, an attribute expression corresponding to an attribute of the subject and an evaluative expression corresponding to an expression of evaluation of the subject is input for outputting an evaluation polarity indicating whether the input reputation information is positive or negative, that causes the computer to execute:
inputting processing for inputting reputation information;
processing for calculating a polarity degree of an attribute expression included in reputation information with a known evaluation polarity;
processing for calculating a polarity degree of a subject included in the reputation information with the known evaluation polarity;
processing for calculating a polarity degree of an evaluative expression included in the reputation information with the known evaluation polarity; and
processing for calculating the polarity of the input reputation information by calculating a comprehensive polarity degree obtained by comprehensively integrating the calculated polarity degrees of the attribute expression, the subject and the evaluative expression.
